(19) United States
(12) Patent Application Publication
(10) Pub. No.: US 2005/0143934 A1
(43) Pub. Date: Jun. 30, 2005

(54) Method and device for the continuous testing of materials

(76) Inventors: Stephan Andreas Schunk, Heidelberg (DE); Torsten Zech, Heidelberg (DE); Alexander Cross, Mainz (DE); Uwe Vietze, Eppelheim (DE); Jens Klein, Heidelberg (DE); Andreas Sundermann, Halle (DE); Wolfram Stichert, Heidelberg (DE)

Correspondence Address: Stephen D Scanlon;Jones Day, North Point, 901 Lakeside Avenue, Cleveland, OH, 44114, US

(21) Appl. No.: 10/497,435

(22) PCT Filed: Nov. 15, 2002
(86) PCT No.: PCT/EP02/12850

(30) Foreign Application Priority Data
Dec. 3, 2001 (DE) 101 59 189.6

(51) Int. Cl. G06F 19/00

(52) U.S. Cl. 702/20

(57) ABSTRACT

The present invention relates to a method for testing building blocks, which are identical or different, of a library of materials, comprising at least two building blocks, for performance characteristics, comprising a sequence of the following steps: 4) testing of at least one library building block for at least one performance characteristic; 5) detecting at least one measurable quantity, to which at least one performance characteristic of the at least one library building block can be assigned by at least one sensor, wherein at least one of the steps (4) and (5) is performed continuously.

The present invention relates to a continuous method for testing materials and material libraries, preferably solid substances, wherein the individual method, steps or operations may be logically combined in order to perform various test algorithms, as well as to a device for performing said method.

In more detail, the present invention originates in the field of high throughput materials research, in particular of high throughput catalysts. It is known that the use of high throughput methods may significantly increase the effectiveness of finding new materials for certain purposes. Therefore, it is important to develop an integrated operation process, comprising all necessary steps of high throughput materials screening in order to test as many materials as possible over a very short period of time.

The fast testing of solid materials, e.g. of heterogeneous catalysts, has until now mostly been performed in such a way that several materials, provided in parallel in a parallel reactor, are subjected to the test conditions simultaneously, and that the materials' performance characteristics are detected. Therein, a plurality of materials, which are typically attached to a carrier substance, are charged into the test apparatus, and that the test program is then started. Such parallel, non-continuous methods for testing of materials are described in e.g. WO '98/15969, DIE-A 19809477.9 as well as in DE-A 1011274.5. In the latter application, a differentiation between methods is possible, wherein the materials to be tested are fixed on a substrate or in appropriate cavities. The methods based on substrates have the disadvantage that the materials cannot be examined independent of the substrate. Depending on structure and properties, the preparation of the substrate may be connected with significant expenses, which is in particular disadvantageous since the substrate cannot be re-used in the direct separation of materials on the substrate. When using test apparatuses with appropriate cavities, the materials have to be charged into these cavities manually or automatically and have to be removed again after the test wherein an additional purification of the cavity is generally necessary. In summary, according to the prior art, the testing of materials is not performed continuously since the test apparatus involve various, discontinuous operation intervals during the test process, caused by e.g. exchanging the materials. An apparatus for testing materials during catalysts, e.g., comprises at least the following states: loading of the apparatus with materials to be tested, setting of the test conditions, performance of the test, setting of the rest conditions (shutting down the apparatus), removal of the tested materials. A relatively large portion of the whole time required for testing the materials results from the steps prior and after the test, required in the context of discontinuous processes. The testing of materials in discontinuous processes therefore requires a period of time of one to several minutes per tested material even in the case of the application of very quick chemical analysis methods.

One strategy for reducing the time required for the necessary steps prior and after the test, was introduced by Muhler et al. (S. Geissler, H. Hanthoff, M. Muhler: “Oxidative Dehydrierung von Ethylbenzol zu Styrol—Katalysatorentwicklung unterstützt durch schnelles kinetisches Screening, Proceedings”, annual meeting XXXIV of German Catalysts in connection with the conference on reactor techniques, Mar. 21-23, 2001, Weimar, Germany). In order to achieve a quick change of a catalyst to be tested, a carrousel provided with individual reactors being automatically set to the respective test position. Rotating the carrousel around a unit moves a new catalyst into the testing position. The number of catalysts to be tested, however, is limited to the number of positions of the carrousel. However, the filling and discharging of the reactors has still to be performed manually. This is a test which is accelerated by automation, non-continuous, and sequential, of catalysts, provided in individual reactor units.

A further concept for exchanging catalysts in catalytic test reactors is described by Jensen et al. (Losey, Schmidt, Jensen: “Microfabricated multiphase packed-bed reactors: Characterization of mass transfer and reactions”, Ind. Eng. Chem. Res. 40 (2001) 2555-2562). Here, special fluid connections lead to a fixed bed catalyst being hydraulically blown in and out wherein this catalyst is present in a micro reactor. This solution, however, merely aims for possibly using the micro-reactor again and not for a fast testing of catalysts. The catalyst test in itself is performed again in a non-continuous manner.

The continuous processing of material samples is e.g. used in the so-called “Coulter Counter” for evaluating the size of particles. The Coulter principle is the standard method for detecting the distribution of particle sizes for particles in liquids. The Coulter principle consists of the detection of sizes and the counting of particles on the basis of changes of the electrical resistance by non-conductive particles in an electrolyte. The measuring zone consists of a small opening between electrodes through which the particles flow. The electrolyte volume, replaced by a particle, can be measured by a voltage impulse, wherein the strength of the pulse is proportional to the particle volume. With this method, being independent of form, color and density of the particle, several thousand particles can be counted per second and their size be measured. With this method, however, only a particle's volume can be determined. Statements concerning chemical properties of a particle or of a material present as a particle are not possible.

The so-called flow cytometry is also based on a similar principle. Therein, particles suspended in an appropriate liquid are individually transported through a focussed laser beam. During the time exposed to the laser beam (approx. 10 ms), fluorescence bodies attached to the particle are incited. The fluorescence emitted is very sensibly evaluated by means of appropriate optics, filter and amplifier. Thus, the particles tested can be counted corresponding to their fluorescence properties, and may be sorted electrostatically. The materials tested are mostly cells, wherein a test ratio of several thousand cells per second can be achieved.

A system for the continuous identification of multi-cellular organisms, already marked, and their sorting for pharmaceutical applications has been described in WO 00/11449 (“Instrument for selecting and depositing multicellular organisms and other large objects”). The organisms or objects to be analyzed are accordingly suspended in an appropriate liquid and are directed individually through a sensor zone. Depending on the result of the analysis, a transfer of objects or a loading of chosen objects into e.g. micro-titer plates can be performed. Therein, the analysis refers to the identification of predetermined characteristics, e.g. the fluorescence of the tested objects. It is also described that the characteristic to be identified may be of chemoluminiscent, phosphorescent, magnetic or radioactive nature. The method described extends the range of application of “flow cytometry” to multi-cellular organisms and micro-carrier bodies of the combinatorial pharmaceutical research. However, there is no teaching as to how the (chemical) properties of materials may be analyzed with the method described. The characteristic of said technique is that the biological samples to be sorted are moving on a single fluidic pathway throughout the whole process, wherein the fluid is the transport medium as well. The instrument described cannot function without this transport medium. This fact puts significant limitations on the range of application of the instrument described. This means, e.g., that the organisms and micro-carrier bodies to be sorted are continuously subjected to the carrier fluid wherein the interaction between the fluid and the organism or micro-carrier body cannot, however, be; evaluated. It is also impossible to use various fluids in various stages of the experiment, which would be of significant importance for a further-reaching testing of materials. The method or instrument described can merely be used for sorting organisms or microcarrier bodies corresponding to a shape of properties created prior to the experiment. It is not possible to examine a new set of properties during the experiment or to analyze the reaction for a defined exposition of the organisms or microcarrier bodies to certain conditions. Moreover, it is impossible to perform chemical analyses on the organism to be sorted or to detect thermal or fluidic effects on the basis thereof. Moreover, the necessary stationary flow of the carrier fluid and the organisms suspended therein make it impossible to perform a synchronized evaluation of the experiment in certain time intervals. Moreover, there is no teaching whether and in which way a sorting exceeding a binary sorting may be achieved. This means that sorting is only possibly in exactly two different classes at a time. Moreover, the system described does not allow to set certain surrounding conditions within the parameter space, e.g. temperature or pressure. Finally, it is not possible to subject organisms or micro-carrier bodies, varying one from the other, to tests at different time intervals.

On the whole, it has to be noted that the system described above allows for an efficient sorting of marked organisms or micro-carrier bodies, however, it does not allow for continuous testing of solid-substance materials on their performance characteristics.

A similar system for sorting of embryos was presented by Furlong et al. (Furlong, Profift, Scott: “Automated sorting of live transgenic embryos”, Nature Biotechnology, 19 (2001) 2, 153-156). Therein, the embryos, in turn marked correspondingly in advance, are optically detected and sorted by means of a fluidic switch.

For the fast (chemical) analysis of liquid samples, biotechnology has been using so-called “serial analysis systems” or “flow-injection systems” for years, which are operated continuously (e.g. WO 00/422 12, “Optimized high-throughput analytical system”). The principle of these analysis systems is that various liquid samples are transported serially, i.e. in sequence, through an analysis system and that one or more properties of the samples are detected at a geometrically defined position in the flowthrough system by means of corresponding methods, most often optical ones. The pertinent systems described in literature, however, do not contain any hint to the way in which the properties of samples provided as solid substance are to be analyzed.

Linden, M. D. et al.—Stud. Surf. Sci. Catal. 1998, 1177,45—describes an example for a method for the continuous production and analysis of solid substances within liquids in tubular-reactor systems. The disadvantage of this method, however, is that only one composition of samples can be tested per analysis unit and that, on the other hand, liquid transport means have to be used.

For the reasons given above, it would be desirable to provide a continuous method for the testing of materials since this might completely or partially eliminate the disadvantages of discontinuous methods.

Moreover, a technology capable of testing material libraries with a very large number of building blocks (>1,000-1,000,000) over a very short period of time, e.g. one second per building block, is highly desirable. Therein, the materials originate preferably from a synthesis such as described in DE-A 10058980.0, and are for the most part not related to a substrate.

Discontinuous test processes generally use material libraries wherein the materials to be tested are provided in a solid, well-defined one-, two- or three-dimensional arrangement on a substrate. This results in the fact that generally all partial steps within the framework of the test method have to be adjusted to this library's geometry. An obvious advantage of a continuous and quasi-continuos test process would be to become independent of such library geometries and thus to achieve a higher flexibility in the examination of the materials to be tested. Thereby, it is possible to subject the individual materials of a present library in accordance with a chemo-mechanical logic, in the sense of logical circuits, to various operations and/or various combinations of operations depending on a prior test result, to create subsets of solid substances of the library in accordance therewith and thus to realize various test algorithms for various materials.

Thus, one object of the present invention is to provide a method which makes it possible to continuously test solid substances as efficiently as possible and to group or screen them in order to overcome known limitations of discontinuous test methods and to significantly increase the number of solid substances to be tested per time interval.

Therein, a method would be particularly advantageous, which could be performed substrate-free. The individual building blocks are in a fixed geometric arrangement with relation to one another in the substrate-dependent material libraries. This has the disadvantage that all building blocks have to be handled simultaneously on one substrate. By comparison, a substrate-free method would be significantly more flexible by reducing the number of building blocks after a first test for performance characteristics since only those characteristics that fulfill the first test's requirements are analyzed further. This results in decisive advantages with regard to the spatial requirements and the time requirements necessary.

Thus, the present invention relates to a method for testing building blocks, which are identical or different, of a library of materials, comprising at least two building blocks, for performance characteristics, comprising a sequence of the following steps:
(4) testing of at least one building block to at least one performance characteristic;
(5) detecting at least one measurable quantity, to which at least one performance characteristic of the at least one building block can be assigned, by at least one sensor,
wherein at least one of the steps (4) and (5) is performed continuously.

Moreover, the method in accordance with the invention may comprise the following additional step (1):
(1) storage of a set M of n library building blocks, wherein n is an integer ≧2.

Moreover, the method in accordance with the invention may also comprise the following further step (3):
(3) formation of at least one partial set Mᵢ out of the set M having a number nᵢ of building blocks, by means of a selecting operation, wherein 1≦nᵢ<n and i is a natural number.

The method in accordance with the invention may further comprise the following further steps (6) and (7), preferably after step (5):
(6) evaluation of the at least one detected quantity from step (5) in an evaluation operation and
(7) partitioning of the building blocks of the at least one partial set Mᵢ based upon the results of the evaluation operation in step (6) into Z partial sets M_{iz}, each with a number of nⱼ building blocks, wherein 1≦Z≦n and 1≦j≦n and j is a natural number, in a partitioning operation,
wherein an unambiguous assignment of the at least one detected measurable quantity to the respective partial set Mᵢ is performed.

Moreover, the method in accordance with the invention may comprise the following step (2):
(2) conditioning of the set M of library building blocks in a conditioning operation.

In addition to the afore mentioned steps, the method in accordance with the invention may comprise the following step (8), preferably following step (7):
(8)combining of partial sets M_{iz}, the building blocks of which were assigned to the same class within the evaluation operation.

More preferably, a step (T) is performed prior to and/or during and/or subsequent to one of the steps (1) to (8):
(T) transport of a set of library building blocks by means of a transport operation via a spatial pathway.

The method in accordance with the present invention is moreover characterized by at least one of the steps being performed continuously.

It is also possible to perform at least the following steps or combinations of steps continuously, wherein the sequence of the steps is not determined:
(1)-(2); (1)-(2)-(3); (1)-(2)-(3)-(4); (1)-(2)-(3)-(4)-(5); (1)-(2)-(3)-(4)-(5)-(6); (1)-(2)-(3)-(4)-(5)-(6)-(7); (1)-(2)-(3)-(4)-(5)-(6)-(7)-(8); (1)-(2)-(3)-(4)-(5)-(6)-(7)-(8)-(T).

Thus, all steps of the method can be performed continuously in accordance with the invention.

Moreover, the method in accordance with the invention is characterized by at least one of the steps (1) to (8) and/or (T) being performable without substrate.

All steps of the method in accordance with the invention may be performed without substrate, too.

The steps (1) to (8) and/or (T) of the method in accordance with the invention may also be repeated and/or combined arbitrarily. This may be true every time for the same step, e.g. testing and/or conditioning, as well as for different steps, e.g. testing and/or conditioning, wherein the first case e.g. aims at a reproducibility of the results and wherein the latter case is related to testing, e.g. by means of different parameters and/or for different performance characteristics. The combination of individual steps, however, does not have to result in a test /screening.

Parts of or the entire steps (1) to (8) and/or (T) of the method in accordance with the invention may be performed under the same or under different sets of parameters P.

The parameter set P may comprise physical, chemical, mechanical and/or biological parameters that are not necessarily constant with time, as well as combinations of two or more parameter sets P.

The testing is preferably performed in a reaction space in accordance with the invention, wherein the geometrical form and/or size and/or position of the reaction space may change prior to, during or after a step or an operation. In a preferred embodiment, the reaction space is a reaction chamber.

The method in accordance with the invention furthermore makes it possible for the steps (1) to (8) and/or (T) or the operations performed in these steps to be performed completely or partially in parallel.

The operations performed in the steps (1) to (8) and/or (T) can moreover be connected dependent on intrinsic and/or extrinsic conditions by means of freely selectable combinations of logical linkages, wherein the logical linkages may be chosen from the group: AND, OR, NAND, NOR, XOR, XNOR, NOT as well as combinations thereof.

An extrinsic condition in this context is a condition which is set from the outside, e.g. a conversion degree of more than 50% to be achieved on a building block in order to be assigned to a certain class. An intrinsic condition is a condition which results in a relation with respect to the total amount of building blocks to be processed. An intrinsic condition would, in this understanding e.g. be the condition that a building block is assigned to a certain class A exactly when the measured conversion degree on the building block exceeds a limit which is defined by the e.g. 10% of the highest conversion degrees of all building blocks measured, i.e. the value of a specific performance property which exceeds a threshold defined by the properties of the library as a whole. A practical method for determining this threshold might e.g. be to subject a statistically representative partial set of the library to a test for a performance property, e.g. the determination of the conversion degree in a chemical transformation, and to detect a defined value for the 10% of the building blocks with the highest conversion degrees from the test results.

In the context of the presented invention the following logical linkages mean:
AND: A statement is true exactly if condition 1 and condition 2 are fulfilled.
OR: A statement is true exactly if condition 1 or condition 2 are fulfilled.
NAND: A statement is true exactly if condition 1 is not and if condition 2 is not fulfilled.
NOR: A statement is true exactly if condition 1 or condition 2 are not fulfilled.
XOR: A statement is true exactly if condition 1 or condition 2 are fulfilled, wherein condition 1 and condition 2 are not to be fulfilled at the same time.
XNOR: A statement is true exactly if condition 1 is not or if condition 2 is not fulfilled, wherein condition 1 and condition 2 are not to be not fulfilled at the same time.

Condition 1 and condition 2 both can be derived from an arbitrary number of sub-conditions as well as the mentioned logical linkages thereof. Moreover, at least one of the conditions 1 and 2 may be a trivial condition.
NOT: A statement is true exactly if one condition 1 is not fulfilled.

In this understanding, a statement being true or false leads subsequently to performing a certain operation or partial operation within the entire test algorithm.

In order to create the at least one condition for the creation of the at least one logical linkage, preferably one operator is chosen from the group: < (smaller than), ≦ (smaller than/equal to), = (equal to), ≠ (different from), ≧ (bigger than/equal to), > (bigger than).

The operators necessary for the realization of logical linkages and other logical operations in the framework of the present invention belong thus preferably to the group of the following operators: < (smaller than), ≦ (smaller than/equal to), = (equal to), ≠ (different from), ≧ (bigger than/equal to), > (bigger than). Preferably, these operators link target quantities and command values. Moreover, combinations of various command and target quantities with equal or various operators are possible for generating a condition and thus a statement, allowing for the directed performance of the method in accordance with the invention.

In accordance with the invention, the steps (1) to (8) and/or (T) as well as the operations performed within the steps (1) to (8) and/or (T) can furthermore be controlled and/or regulated partially or completely in an automated manner.

The partially and/or completely automated regulation or control of the steps (1) to (8) and/or (T), as well as of the operations performed within the steps (1) to (8) and/or (T) can furthermore be self-optimized or optimized partially or completely within an expert system (as a part thereof) or in connection with an expert system.

The operations are generally designed in such a way that a very simple transition between individual operations, linkages of operations etc. is possible. The devices for performing the operations are thus preferably modular and have defined interfaces to other modules. The interfaces are shaped in such a way that negative effects of the performance of operations in one module are not transferred to the next module. It is guaranteed, e.g., that undesired impurities are not transferred from one module to the next. In principle, it is possible to perform one operation based on one module, however it is also possible to perform one operation based on two or more modules. It is also possible that at least two or more operations are performed within one module. The modules are in principle capable of performing the desired operation, partial operation or the desired operations. Additionally, there may be at least one further operation modus each, allowing for regeneration of the module after performing an operation, e.g. a purification; thus, the modules can be continuously operated without interruption. This process can avoid or minimize cross-contamination of the test results between different building blocks of a library. Operations may also be steps, wherein one operation is to be considered equal to a step or operations are considered equal to steps.

The materials of the devices used for performing the operations are in all cases chosen in such a way that they are compatible with the problem o be solved or examined in the testing and/or production of the building blocks. This means that, e.g. for catalytic examinations, materials are chosen which are inert or substantially inert as well as of sufficient temperature and pressure resistance. In preferred embodiments, microstructured building blocks and/or combinations of microstructured and macrostructured building blocks are used for performing various operations. The use of microstructured building blocks, i.e. of building blocks and/or modules made by means of methods of microtechnology, is generally connected with a substantially higher precision in the performance of the operations. In preferred embodiments, this also relates to the realization of modules for performing operations wherein there are no or only very small amounts of unused volumes. In general, solutions with little or no unused volumes as well as very short transportation paths and little reaction volumes are preferred in order to reduce the test speed, i.e. the test duration necessary per building block, and to optimize the whole test process with regard to speed. This process has the advantage that the rate determining step for the testing of building blocks is reduced to the intrinsic behavior of the building blocks in the test. Thus, e.g., the time necessary to reach equilibrium or the minimal reaction time for the observation of a property under conditions can be reduced, with these times being important for understanding the behavior or the properties of the tested building block. This is particularly important for the process of upscaling.

In preferred embodiments, the individual devices for performing operations are provided with means allowing for eliminating by-products or reaction products created during the performance of operations or other undesired physical impairments. Concretely, this refers to the defined discharging of rubbed-off parts of the building blocks to be tested and/or mechanically operated parts of the device as well as to the discharging of condensed or crystallized reaction products or similar.

The present invention thus also relates to a device for the continuous testing for performance characteristics of building blocks being identical of different, of a library of materials, comprising at least:
(3) means for adding and/or discharging at least one fluid medium; and
(4) means for testing the building blocks for at least one performance characteristic.

Moreover, the device in accordance with the invention may comprise:
(1) at least one storage container with a set M of building blocks and/or
(2) at least one device for creating the at least one partial set Mᵢ form the amount M with a number nᵢ of building blocks and/or
(5) means for intermediate storage of building blocks and/or
(6) means for the transport and/or substrate-free transport of the building blocks and/or
(7) means for the conditioning of building blocks and/or
(8) means for screening the building blocks and/or
(9) means for automation.

The device in accordance with the invention is furthermore characterized by the means for automation being partially or completely interconnected within an expert system.

The present invention moreover relates to a device for the continuous conditioning and production or continuous conditioning or production of building blocks which are identical or different, of a library of materials comprising at least:
(1) at least one storage container with a set M of building blocks and/or
(2) at least one device for creating at least one partial set Mᵢ form the amount M with a number nᵢ of building blocks and/or
(3) means for charging and/or discharging at least one fluid medium.

Moreover, the present invention relates to a method for the conditioning and/or production of building blocks which is characterized by being performed continuously.

Moreover the method in accordance with the invention may be used for implementing identical or different algorithms for the production, processing and/or testing of building blocks of a library of materials.

The device in accordance with the invention is preferably used for performing the method in accordance with the invention for the continuous testing and/or production of heterogeneous catalysts.

Finally, the present invention also relates to a computer program with program-code means for the application of the method in accordance with the invention and/or controlling of the device in accordance with the invention, as well as to a data carrier containing said computer program.

The terms used within the present application are explained in the following:

Analysis: Analysis in accordance with the invention is to be understood to be all! analysis technologies used for the testing of materials within a library of materials, for detecting their properties, e.g. performance characteristics.

The following analysis technologies are mentioned by way of examples: infrared thermography, infrared thermography in combination with mast spectroscopy, mass spectroscopy, GC, LC, HPLC, micro-GC, disperse FTIR spectroscopy, Raman Spectroscopy, NIX, UV, UV-VIS, NMR, ESR, GC-MS, infrared thermography/Raman Spectroscopy, infrared thermography/disperse FTIR spectroscopy, color detection with chemical indicator/MS, color detection with chemical indicator/GCMS, color detection with chemical indicator/disperse FTIR spectroscopy, photo-acoustic analysis, electronic and electro-chemical sensors as well as tomographic NMR and ESR-methods. Moreover, combining two or more of these analysis methods as well as connecting them in parallel is possible, e.g: in parallel gas chromatography.

In general, the detection of chemical, physical and physical-chemical properties is possible. Therein, specific properties, e.g. magnetic, electric, electro-magnetic and/or piezo-electric properties, can be preferably analyzed. Fast measuring methods are particularly preferred.

By way of example, infrared thermography with emissivity correction may be performed wherein the correction is effected by means of differentiating a first picture, being taken in advance without chemical reaction, and a second picture with chemical reaction by means of an infrared camera (see e.g. WO 99/34206). In case of a small number of building blocks, a temperature sensor may be assigned to every individual building block, if need be, e.g. a pyrometric building block or a thermo-building block.

The building blocks can be analyzed for performance characteristics in parallel or in sequence.

Selecting operation: The selecting operation serves the purpose of selecting a discrete subset Mᵢ of the set M with the number O building blocks, wherein 1≦O≦N, and is preferably used in combination with the storing operation and the transport operation. The selection criterium may be random or specific. When performing the selecting operation, mechanical and physical methods known to the person skilled in the art for selecting building blocks from a set of building blocks are used in order to create discrete subsets Mi and to separate them from the initial set M. Preferably, pneumatic transport methods (applying of overpressure or low pressure), mechanically actuated building blocks, optical pliers, sound fields, electrostatic methods, magnetic methods, piezo building blocks, gravitation and the like, as well as combinations of the aforementioned methods are used. Among the mechanical methods, wheels, combs, conveyor belts, screws, “revolving door”, picker and the like are preferred. These methods are preferably used during a defined time interval until the required subset has been formed. Preferably, this subset is subsequently forwarded to the transport operation, being responsible for the further processing of the subset. Preferably, the selecting operation is used in such a way that, starting with a subset M with number of N building blocks, exactly one building block is randomly or specifically selected and forwarded to the transport operation. Preferably, the selected building blocks are in a defined, preferably stationary (as far as the reaction is concerned) state throughout the entire selecting procedure. This may be ensured e.g. by the specific building blocks being flown over with a fluid for conditioning and/or reacting throughout the entire selecting process or by subjecting the chosen building blocks to a defined pressure as well as to a defined temperature. The aforementioned treatment can also be applied to sections. These means ensure that the building blocks are already in the state desired when entering the next module or when traversing to the next operation.

Building block: The term “building block” refers to an individually defined unit, present individually or in groups (subsets) within the inventive device and consisting of one or more components or materials.

Such building blocks in the framework of the present invention are preferably non-gas-like substances, e.g. solid substances, liquids, brines, gels, wax-like substances or substance mixtures, dispersions, emulsions, suspensions and solid substances, particularly preferably solid substances. Therein and within the frame-work of the substances used in accordance with the invention, these may be molecular or non-molecular compounds or formulations, or mixtures or materials, wherein the term “non-molecular” refers to substances which may be continuously varied or changed, as opposing to “molecular” substances, the structural form of which may merely be changed by varying discrete states, e.g. varying a substitution pattern.

The composition of the building blocks comprises the stoichiometry as well as the overall and elemental composition of the materials to be tested, which may differ from one material to the other. Thus, it is possible in accordance with the invention, to produce or test material libraries, comprising materials which are identical with regard to their elemental composition wherein, however, the stoichiometric composition of the building blocks forming the material, differs between the individual materials. Moreover, it is possible that the library of materials consists of materials differing with regard to their elemental composition; it is also possible for the individual materials to differ with regard to their stoichiometric and elemental composition. Moreover, it is possible, that the library of materials consists of building blocks which are identical with regard to their elemental composition and stoichiometric composition, but differ with regard to their physical or chemical or physical-chemical properties as a result of a treatment step. Here, the term “element” refers to elements of the period system of the elements. The term “substance” herein refers to materials, components or precursor components, leading to a material.

According to the inventive process, the building blocks may vary arbitrarily and in a simple way and may include: e.g. heterogeneous or heterogenized catalysts, luminophores, thermo-electric, piezo-electric, semi-conducting, electro-optical, supra-conducting or magnetic substances or mixtures of two or more of these substances, in particular inter-metallic compositions, oxides, oxide mixtures, mixed oxides (e.g. mixtures of two or more oxides), ionic or covalent compounds of metals and/or non-metals, metal alloys, ceramics, organo-metallic compositions, and compounds, dielectrics, thermo-electrics, magneto-resistive and magneto-optical materials, organic compositions, enzymes and enzyme mixtures, pharmaceutical drugs, substances for animal food and additives thereof, substances for food and additives thereof, and cosmetics. It is also possible that a multitude of materials, that are similar for the most part, however, differ with respect to at least one element are tested, thereby allowing to test all variations of one particular material containing at least two elements.

The respective building blocks may be identical or different, wherein the latter is preferred.

The building blocks are preferably present in the form of individual bodies such as beads, monoliths, cylindrical bodies, etc. A building block may also be comprised of a multitude of identical or different individual bodies wherein powder-like building blocks are possible in this context. Therein, these powder-like building blocks are preferably handled and geometrically determined by means of appropriate devices, e.g. containers (receivers) with corresponding loading and de-loading components, which may additionally be provided with membranes (cf. DE-A 10117275.3 for corresponding membrane embodiments), in order to be able to perform individual inventive steps or operations.

Subsets of building blocks may also be grouped on and/or in appropriate devices and may then be subjected, preferably, to a continuous testing process.

In order to produce the building blocks, all production processes known to the person skilled in the art may be used. Such production processes are known from; e.g., combinatorial materials research. In particular, it is referred in this context to DE-A 100 59 890.0, describing a “method for producing a multitude of building blocks of a library of materials” which is included in the entire extent into the context of the present invention. Accordingly, it is referred to the production processes described in DE-A 100 42 871.1 as well as WO 99/59716.

The production of building blocks can be performed outside as well as inside the inventive device, wherein a partial or pre-production, performed outside the inventive device, in combination with finishing of the building blocks performed within the inventive device, is possible, in particular in view of the fact that a building block may consist of more than one components.

In a preferred embodiment of the present invention, a building block of the library is a defined body of arbitrary form, e.g. a bead, a cuboid, pellet, tablet or the like, present in a mechanical stability sufficient for the testing steps to be performed. If, however, the materials to be tested are heterogeneous catalysts, bead-shaped full catalysts, bead-shaped shell catalysts or bead-shaped supported catalysts are preferably used. The diameter of the ball-shaped building blocks is preferably within the range of 1 μm to 50 cm, more preferably within 10 μm to 1 cm and still preferably from 50 μm to 5 mm.

In another preferred embodiment, the bodies have a metallic core o are otherwise magnetized so that one ore more magnetic fields may be used for transporting and handling of the building blocks.

In another preferred embodiment, the present invention can also test powder-shaped or fixed-bed materials with respect to their performance characteristics. In order to easily transport such a powder and to make it possible for the powder to be tested in conjunction with other building blocks, the building blocks may be provided in certain building block containers (preferably one building block per container), allowing for adding and/or removing of fluids, and the like to the building block. In the simplest case, theses containers are provided with flits or membranes. The containers may be open or closed wherein in preferred embodiments it is possible to reversibly close the container in order to enable the re-opening of the containers after the test method is finished. Moreover, it is possible to provide an automatic opening of the containers for individual test operations in order to perform a test for preferably one performance property, e.g. an XRD characterization of a powder. After such an operation has been terminated, the container may be closed again and directed to the next operation. An example for a special embodiment of the containers are the Kan™ reactors, commercially available from the company Irori, San Diego, Calif.

In a special embodiment of the invention, powder-shaped material in containers are used, synthesized directly within the containers, e.g. by using the method described in DE-A 10059890.0. In another preferred embodiment, the containers are additionally provided with a feature allowing for an unambiguous identification of the container and the material contained therein. For such a coding, methods may be used which are inert during the performance of the testing method and which are sufficiently stable against surrounding conditions. Examples for such methods are described in DE-A 10117274.5 as well as DE-A 10117275.3, and are included into the context of the present invention in their entire content. Moreover, building blocks which are not present in a container may be provided with a code for identifying the building block. Examples for such methods are also described in DE-A 10117274.5 and DE-A 10117275.3, which are also included into the context of the present invention in their entire content in this respect.

Storing operation (storage): The storing operation comprises the storing and memorizing of a defined amount of building blocks of a library of materials in a defined geometric entity/container (e.g. storing or feed container) under defined conditions. If the storing is effected in combination with the eon itioning, additional measures may be performed, avoiding cross-talk between the building blocks, e.g. sticking of the building blocks to each other. As possibilities are to be named, e.g., mechanical treatment, rinsing, rinsing for removing rubbed-off parts, removal of undesired products, e.g. drainage of condensates and the like. The storing operation may be performed at random stage within the test algorithm as well as at the beginning and the end. The building blocks of the library of materials may be randomly distributed or spatially addressable within the storing module, e.g. as a fluid bed in suspension or in agents under thorough mixing and preferably aeration with e.g. pressured air or gas.

Evaluation operation (evaluation): The evaluation operation serves for evaluating one or more measuring values obtained in the test operation for one or more building blocks in relation to one or more defined reference values or obtained on an absolute scale. The purpose of said evaluation is to draw a logical conclusion for the further process of the test algorithms with respect to the building block or building blocks tested. The evaluation operation is preferably performed using a data processing facility and can, however, also be performed directly as a reaction to a measured value, e.g. mechanically, e.g. by the reaction of a bi-metal to a temperature change, caused by a building block when testing for a performance property, or also electrically, e.g. by an electrical switch, not responding unless a certain voltage is achieved as a reaction for measured performance characteristics of a building block. If the evaluation operation is performed by a data processing facility, e.g. a computer, it includes means by which the logical conclusions or instructions for the logical and technical-physical transformation of the logical conclusion can be communicated to one or more other operations.

Depending on the algorithm to be performed, the logical conclusion may have various expressions. A typical, preferred logical conclusion is the assigning of a building block to a certain class. This conclusion is subsequently effected by the following operations. In a preferred embodiment, the geometric assignment of the building block to a class of building blocks in an accumulation container (storing operation) is performed by means of a conditional transport operation. Another preferred logical conclusion is the conditional coding of a building block in a classification operation, e.g. by marking with fluorescing substances or radioactive substances. With regard to more details of a possible coding of building blocks, it is referred here to DE-A 10117274.5, the contents of which in this respect are included into the context of the present application. Another consequence of an evaluation operation is the conditional amendment of the parameter set P with regard to the test operation. In a preferred embodiment, this means that the building block is subjected subsequently to another test under amended test conditions (new parameter set P) in the same reaction chamber when fulfilling a defined test criterion, e.g. an achieved transformation degree in a chemical reaction. In another preferred embodiment, the logical consequence may be that, when fulfilling a defined test criterion, e.g. an achieved transformation degree in a chemical reaction, another analysis method, e.g. mass spectroscopy, is used for more detailed analysis of the product mixture in addition to the analysis method used in the first test (infrared thermography).

The evaluation is performed in a way that may include a logical operation, i.e. generally in discrete steps. On the basis of the evaluated measuring values, the corresponding building blocks are assigned preferably to discrete, defined classes. The number of classes possibly formed is not limited in principle. Preferably, two classes (0/1, low/high, loser/winner) are defined with regard to a pre-defined threshold value for the size of the measuring value. In a further preferred embodiments, however, the creation of three or more classes is also possible. These evaluation criteria or threshold values may also be determined after the detection of the measuring values or be newly defined, wherein access to certain position is possible e.g. in an embodiment wherein the building blocks are lined up on a chain, e.g. collected in a channel. Access to, e.g., the second, fifth and ninth building block is then possible.

The physical assignment of the building blocks to the corresponding class is performed subsequently by a classification operation. If the evaluation operation is dependent on the material composition of the tested building block (if e.g. the test operation(s) include such characterization), it is not always necessary to perform a physical classification of the building blocks. In a preferred embodiment, the result of the evaluation is then assigned to the material composition of the building block and not to the building block itself. This relation is given as an output in a way known to the person skilled in the art and/or is stored electronically.

First-order properties: First-order properties within the framework of the present invention, for the most part, relate to those expressions of properties which may be obtained by means of physical characterization methods, e.g. X-ray diffraction, LEED structure determination, EDX, X-ray fluorescence analysis, X-ray photo-electron spectroscopy, Auger spectroscopy. Examples for first-order properties are: atom distance, elemental composition, etc.

Second-order properties: Second-order properties are those expressions of properties which are accessible by means of physico-chemical characterization methods, e.g. nitrogen adsorption (surface dimensions (BET)); TPD (bonding strength of absorbates to surfaces or selective chemisorption—sizes of the surfaces of active centers).

Expression of properties: The term expression of properties relates to physical, chemical or physical-chemical states of the individual materials within the library of materials; examples are: oxidation state, crystallinity.

The testing of building blocks with respect to at least one performance property is performed within the analysis preferably by means of a separate analysis station. The analysis stations may also be pooled together. It is also possible to use a separate analysis facility for every property to be examined.

The possibility of contacting the building blocks with fluids and/or radiation such as magnetic fields, light, UV-VIS, XRD, microwaves, etc. renders the testing of a multitude of performance characteristics possible, making statements with regard to whether the building blocks are appropriate catalysts, thermo-electrics, supra-conductors, magneto-resistant materials etc.

Expert system: An expert system is at least one program (computer program), that makes decisions by means of artificial intelligence and access to a data bank which is preferably very extensive. An algorithm for determining the consequences and a data bank are used by this system for diagnoses. In connection with automated sequences (e.g. work processes), such expert systems can optimizingly influence the sequences. One aim of such a connection (interconnection) of an expert system with a partially or entirely automated work process is e.g. the self-optimization of this work process.

Liquid: A liquid is a medium, the shear flow of which is proportional to the expression e-^{ΔE/RT} wherein AE is the energy to be overcome in order for the medium to flow. Liquids, gases, waxes, dispersions, fats, suspensions, melts, powder-shaped solid substances etc. rank among them. If the medium is liquid, multi-phase liquid systems are included.

Classification operation (classification): In the classification operation a physical classification of the tested building blocks is performed corresponding to the result of the evaluation operation. In a preferred embodiment, flip classification operation is thus a conditioned performance of a transport operation, coupled with the evaluation. Corresponding to the fulfillment or non-fulfillment of logical conditions which have been derived in the evaluation operation from the result of the evaluation in the form of a logical conclusion, one or more directed transport functions are performed. By means of these transport functions, conditioned logical circuits are realized mechanically and/or physically in order to determine the further test algorithm for the classified building block or building blocks. Thus, chemical properties, detected in the test operation and evaluated in the evaluation operation are transformed directly into a physical classification. The transport of the building blocks is principally performed by means of methods known to the person skilled in the art, e.g. mechanical or physical ones. Preferably, pneumatic transport methods (applying of overpressure or low pressure), mechanically actuated building blocks, optical pliers, sound fields, electro-static methods, magnetic methods, piezo building blocks, gravitation and the like as well as combinations of the aforementioned methods are used. Wheels, combs, conveyer belts, screws, impeller wheels, pickers and the like are preferred among the mechanical methods. Besides the mere transport function, a continuous, thermally and reaction-technically seamless transformation between individual operations and/or modules is realized in the transport operation. Preferably, the transported building blocks are, during the entire transport, in a defined, preferably stationary (reaction-technical) state. This may be achieved, e.g., by the whole transport path definedly, also by sections, being flown through with fluids for conditioning and/or reacting, and/or being subjected to a defined pressure as well as being kept at a defined temperature, also by sections. These means guarantee that the building blocks are already in the desired state when entering the next module or transfer-ring to the net operation. The number of classes to be created i˜ not limited in principle. Preferably, the building blocks are physically assigned to two classes. However, the creation of two or more classes is possible. In a preferred embodiment, the classification of building blocks in a spatially addressable way is possible so that the test result can later on be assigned to an individual building block along its spatially addressable location. This spatially addressable classification is preferably performed in such a way that the building blocks are stored in a defined format, e.g. a microtiter plate. Therein, the possibility exists of filling all building blocks of the same class in the same or in equivalent arrays. It is also possible that all building blocks are filled in one array or a form equivalent thereto and that building blocks are later on removed by a picker, e.g. those to be assigned to a certain class (i.e. re-sorting from out of the array).

In a further preferred embodiment, the classification is performed by coding the building blocks of the library of materials. The classification operation can be performed once or several times at one or more stages within the test algorithm. If the classification operation is performed at the end of a test algorithm, the assigning of the tested building blocks to the classes provided is preferably effected in such a way that the building blocks can be further processed in the integrated high-throughput work process without problems.

Conditioning operation (conditioning): The conditioning operation includes the conditioning of a defined set or subset of building blocks of a library of materials under defined conditions, which may be described by the parameter set P. The parameter set may include physical, chemical, mechanical, and/alt biological parameters including time-dependent parameters as well as random combinations thereof. If the building blocks are heterogeneous catalysts, the conditioning is e.g. performed under reaction conditions in order to achieve forming (activating) and/or aging of the materials. Heat treatments, oxidations and/or reductions of the catalyst, agings with pollution gases, regeneration etc. A vapor treatment as well as hydro-thermal treatments and/or treatments with radiation are possible as well.

The pre-treatment or conditioning may also be a single-step or multi-step calcination of the catalyst precursor under one or more defined atmospheric conditions. In principle, it is also possible to subject the building blocks to an electric, electro-chemical or optical treatment or excitation. Moreover, random combinations of the aforementioned parameters and states are possible.

In a special embodiment, the conditioning operation additionally consists of subjecting an individual building block or a defined set or subset of building blocks in a continuous way, in accordance with the invention, to one ore more substance-transport processes or one ore more substance-exchange processes. Therein, sub-stance-transport and substance-exchange processes are possible with gas-like, liquid and solid mediums or medium mixtures, as well as chemical reactions with gas-like, liquid and solid mediums and medium mixtures.

In a special embodiment, the conditioning operation consists of at least one defined substance amount being applied to individual building blocks or several building blocks. Therein, synthesis methods such as described in DIE-A 10059922.2, DIE-A 10042871.1 and DIE-A 10059890.0 may be used. Such sub-stances and or substance mixtures applied to the building blocks may be reacted by the effect of chemical, physical and/or physical-chemical parameters, thus achieving a conditioning of the building blocks.

Preferably, the conditioning is performed under stationary conditions with regard to the conditioning parameters in order for the building blocks of the library to be in a stationary state for the operation that follows. In this case, the conditioning is e.g. performed in such away that the building blocks of the catalyst library are continuously flown over with reaction gas of a defined composition (e.g. 1% hydrocarbon in air) and a defined amount under a certain temperature and a certain pressure.

However, changes of the parameter set with time in the conditioning process are also possible for realizing a conditioning program. This is sensible, e.g., in cases where the building blocks of a library of materials have to be activated prior to the test and in accordance with a certain, defined procedure in order to achieve an optimum catalyst performance.

The conditioning operation is preferably realized in combination with the storing operation for a set or subset of the building blocks to be tested. In a preferred embodiment, the conditioning is also performed on a subset consisting of as many building blocks as can be simultaneously tested in the test operation. If e.g. a test operation is performed on an individual single building block, this building block is preferably individually conditioned under exactly the same parameter set to which it is exposed during the test operation, however, prior to the test operation. This avoids non-stationary states as far as possible and thus achieves thigh throughput speed in the test operation. The conditioning operation is preferably performed prior to the test operation. It is, however, also possible to perform a conditioning operation, e.g. subsequently to the test operation, for re-conditioning the building blocks in order to prepare them for the next operation. The conditioning operation can be performed at an arbitrary position within the test algorithm as well as at the beginning and end as well as in series more than once. As an example, first synthesis occurs, followed by calcination more than once.

Continuous: The term “continuous” in the framework of the present invention is to be understood as a continuous or steady flow of building blocks according to the inventive method as well as by means of the inventive device, taking place between the one or more inlets and the one or more outlets of the method and/or the device and the one or more outlets of a partial step of the method and/or a! partial device of the device. The term also includes a limited stopping of the building blocks, preferably within seconds, for performing operations. Possible operation states may be: all building blocks moving continuously; all building blocks in continuous movement preferably between two or more steps or operations and during the performance of one or more operations in a short standstill; combinations in such a way that, although building blocks are continuously moving during the performance of one or more operations, of one or other operations, however with a short standstill of the building blocks in the device performing the operation. A “short standstill” corresponds to a building block standing still for preferably a short period of time on a fixed geometrically defined position within a device or partial device, preferably until the performance of a certain operation, e.g. the detection of a performance property of the building block, is concluded.

Thus, the inventive method or the device for performing the method of the invention can be called “continuous” exactly if at least one building block once is added in a defined time interval through the at least one inlet into the process or the device or into a partial step of the process or a partial device and/or is removed through the at least one outlet from the process or the device or from a partial step of the process or a partial device wherein the defined time interval between the adding and/or removal of a first partial set of building blocks and a second partial set of building blocks as well as between the second partial set of building blocks and a third partial set of building blocks may be identical or differ from each other. Therein, the continuous method is performed in at least one device. The possible brief stop of the building blocks is preferably within the range of 0.01 seconds to 10 minutes, particularly preferably within the range of 0.1 seconds to 60 seconds. Preferably, the transport operation is therein performed automatically.

In a preferred embodiment, the term “continuous” relates to the fact that at least one building block is relocated during at least one operation relative to at least one other building block of the library for a defined period of time.

Logical test algorithm: A logical test algorithm within the framework of the present invention is understood as a method leading to the solution of a certain problem in a finite number of unambiguously determined operations, wherein each algorithm may be performed automatically by the defined assembly and logical interconnections of devices performing operations. The problem o be solved is therein e.g. a test of a number of building blocks for one or more performance characteristics as well as the subsequent classification of the building blocks in accordance with the results of the test for performance characteristics. Analogously, logical conditioning algorithms and logical algorithms for the production of building blocks may be defined.

Performance characteristics: Performance characteristics are measurable properties, preferably catalytic properties (e.g. catalytic activity and/or selectivity) and/or such of first or second order, of the building blocks of the library of materials, which are detected by means of appropriate sensors within e.g. an automated testing (analysis).

Substrate-free: As explained above in the prior art section, building blocks have to be positioned on fixed locations (substrates, arrays) in the knot methods. By contrast, according to the invention, building blocks are processed substrate-free, wherein substrate-free means that the building blocks are not bound to a location. This means that the building blocks may change their geometrical position relatively to or within the inventive device during the inventive process and/or that the building blocks are preferably also geometrically independent from one another. Substrate-free also means that the geometric form, size and position of a cavity (reaction chamber) is variable. This variability can e.g. be achieved by a combination of the cavity from various components or compartments of the device of the invention, wherein these are preferably movable or displaceable independently from each other by means of automation.

Test operation (testing): The test operation includes the performance of a reaction or the exposing of the building block or building blocks to be tested to test conditions (reaction conditions) as well as the direct or indirect analysis of the response of the building block or building blocks to this exposition. In the test operation, the building block to be tested is tested under defined conditions which may be described by a parameter set P which may be identical or different for various building blocks. The parameter set may include physical, chemical, mechanical and/or biological parameters including time dependent parameters as well as random combinations thereof. If a test is performed with respect to the catalytic properties of a building block, the building block is, e.g., contacted in a well-defined manner with fluid reactants under certain temperature, pressure and flow-conditions.

In a preferred embodiment of the present invention, the building block to be tested is placed in a position directly defined within the device for performance of the test operation during the test operation. For example, a building block is positioned within a defined position within a reaction chamber, e.g. a micro reaction chamber, and is contacted with fluids in this position. As an example for a performance property, the building block is subsequently tested by means of an analysis of the fluids or reaction products flowing off the building block. It is determined whether the building block displays a certain catalytic property, e.g. the ability to partially oxidize a hydrocarbon in the presence of air or oxygen. The reaction chamber defines a three-dimensional spatial cavity which is equipped with at least one fluid inlet and at least one fluid outlet.

The reaction chamber is, however, not necessarily a geometrically defined spatial cavity that is constant with time. In a preferred embodiment it is e.g. possible that the corresponding reaction chamber is created by the relative positioning of two or more building blocks of the inventive device for performing the test operation. This relates to parts of the three-dimensional cavity and/or the fluid inlet and/or the fluid outlet. Preferably, the reaction chamber is formed as a circular device, a comb, a conveyor band, a screw, an impeller wheel, a trolley, a hose, etc. and is preferably formed as a combination of various hollow spaces and/or parts of the inventive device. Here, the reaction chamber's geometry may change during the steps or operations.

In the reaction space as described above, dimension-less characteristic numbers are preferably used as relevant parameters in the case of industry-related reaction technical embodiments (Levenspiel, Octave: Chemical Reaction Engineering, Third Edition, 1999, John Wiley & Sons, Inc., p. 660 and 661, DE-A 10117275.3). Here, the reaction space is preferably formed in such a way that just very little or no dead volumes prevails. A dead-volume-free or dead-volume-lean geometric creation of the reaction chamber has the advantage that very short response times can be achieved when testing a new building block. Additionally, longer rinsing times can be avoided as well as zones with undesired condensate sedimentation or sedimentation of rubbed-off parts can be reduced.

Directly after testing a building block in the test operation, the tested building block is taken over by the transport operation and handed over to the next operation in the algorithm. Simultaneously, an additional transport operation transfers the next building block for testing to the test operation or the afore-described reaction chamber. This next building block is then immediately tested for preferably one performance characteristic. Here, the test can be started immediately in a preferred embodiment since the building block is already in a stationary state by means of the previous conditioning operation.

In a further preferred embodiment, the building block is subjected to defined stationary conditions. Therein, an analysis of performance characteristics of the building block is performed, which may be effected in accordance with methods known to the person skilled in the art. Preferably, methods are used by means of which an analysis of performance characteristics may be effected during a time interval of less than 10 mm., more preferably of less than 1 mm., even more preferably of less than 10 s and even more preferably of less than 1 s per building block. Corresponding to the assembly of the test operation within the test algorithm, it may be defined which performance characteristics are be tested and which information depth is to be achieved therein. In a preferred embodiment, the methods for analyzing performance characteristics are categorized corresponding to their information depth into Boolean methods and methods with higher information depth. Boolean modules provide, e.g., a Yes/No information concerning the efficiency of a building block regarding a performance property, e.g. the activity of the building block as a catalyst within a heterogeneously catalyzed reaction. Another possible Boolean information is the presence of a certain product molecule. Such information can e.g. be detected by means of analyzing techniques such as photo-acoustical spectroscopy, JR-transmission, IR-emission, thermal deflection spectroscopy, Raman spectroscopy or optical indicator detections. In a preferred embodiment, Boolean methods are combined in order to achieve better statements regarding the performance characteristics examined. As an example, the combination of photo-acoustical spectroscopy and IR thermography is mentioned. Infrared thermography can, e.g., prove the activity of a building block, while, e.g., photo-acoustical spectroscopy can subsequently indicate the amount of CO₂ produced. On the basis of certain evaluation regulations in the evaluation operation, corresponding categorizations are possible starting therefrom. Higher information depths such as graduations in the activity or selectivity can, e.g., be obtained by means of methods such as MS, GC, GC-MS and multi-dimensional infrared sensography.

In another preferred embodiment, the performance characteristic of the building blocks are tested under transient conditions.

Transient conditions: In accordance with the present invention, transient conditions are understood to be instationary conditions wherein, preferably with regard to one or more parameters of a parameter set P, a continuous or discontinuous change is performed. The parameters are then preferably generated depending on said changes.

Here, testing under transient conditions means that the parameter set P for the building block to be tested changes at a certain point of time, e.g. depending on the composition of the fluid flowing over the building block. This is advantageous if the building blocks to be tested have a distinctive deactivation behavior, e.g. within a few seconds, and if this is to be examined (e.g. FCC—fluidic catalytic cracking). The testing under transient conditions is also interesting if the dynamics of a building block in relation to the change of the parameter set P is to be examined as a performance property. This is interesting, e.g., if the dynamics of building blocks is of particular importance, e.g., in the case of material for automotive applications, e.g. of NOx-storing catalyst for the exhaust gas treatment in Diesel vehicles.

Transport operation (transport): The transport operation serves for the transport of a set of building blocks of the library of materials with a number of building blocks T with 1≦T≦N between various operations or between and/or during different modules. Thus, the logical interconnection between and/or during operations and modules is effected and the realization of logical test processes or logical test algorithms is made possible.

The transport of the individual building blocks of the library of materials, of a partial set or the whole set of building blocks of the library of materials is therefore possible. Therein, the transport of the building blocks can be principally be effected by means of methods known to the person skilled in the art, e.g. mechanical or physical ones, Preferably, pneumatic transport methods (applying overpressure or reduced pressure), mechanically displaced building blocks, transport fluids, optical pliers, fields of force in general, acoustic fields, electrostatic methods, magnetic methods, Piezo building blocks, gravitation and the like, as well as combinations of these methods are used. Among the mechanical methods the following are preferred: wheels, combs, conveyor belts, screws, “revolving doors”, impeller wheels, pickers (e.g. pick-and-place devices), pliers, grippers, trolleys, hoses, and the like and/or combinations thereof. Mechanical methods may also be appropriate for transporting partial sets with more than one building block. Besides the simple transport function, a seamless transfer of fluids, thermal transfer and reaction-technical transfer is realized between individual operations and/or modules during the transport operation in a preferred embodiment. Preferably, the transported building blocks are in a defined, preferably stationary (reaction-technical) state during the whole transport path. This may lie guaranteed by the whole transport path being flown over in a defined manner, also by sections, with fluids for conditioning and/or reaction, and/or by the transport path being subjected to a defined pressure and kept at a defined temperature, also by sections. These measures ensure that the building blocks are already in the state as desired when entering the next module or transferring to the next operation. This e.g. allows for instant testing of the building blocks in the test operation and a stationary test state of the building block is achieved without loss of time. In general, low dead volumes are advantageous for accelerating the operation. Besides the transport function, a further operation mode may be realized, enabling the rinsing and purification of the module as used and freeing it from undesired sediments (rubbed-off parts, condensates, remaining gas amount, etc.). The transport path may be shaped geometrically in such a way that undesired sediments such as rubbed-off parts and condensates precipitate at defined locations with in the transport system and are therefore collected and removed in a well-defined manner. The transport operation can be performed at arbitrary location within the test algorithm as well as at the beginning and end thereof.

Further details of the invention are explained in more detail in the Figures by way of schematic embodiments.

It is shown specifically:

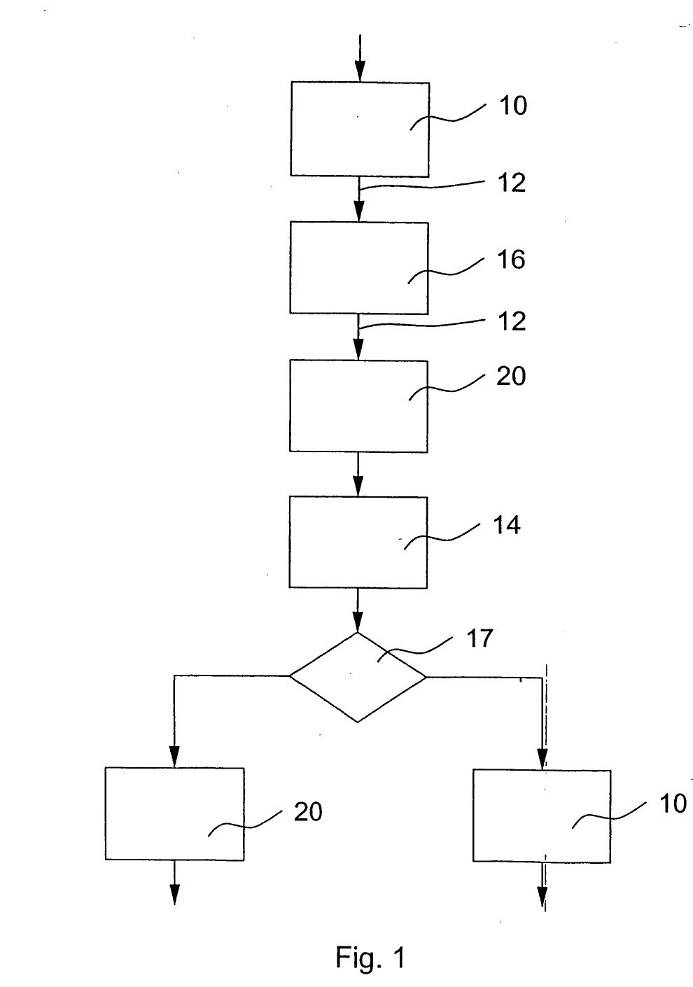

FIG. 1 schematic representation of the principal assembly of the steps or operations of the method of the invention;

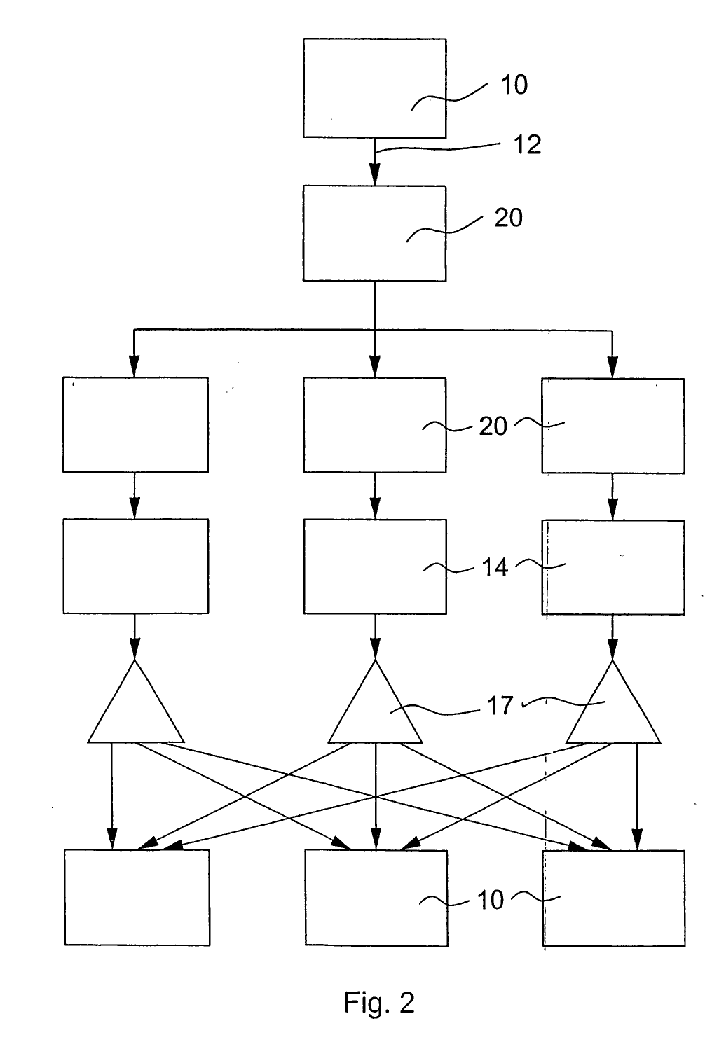

FIG. 2 parallel processing/process performance

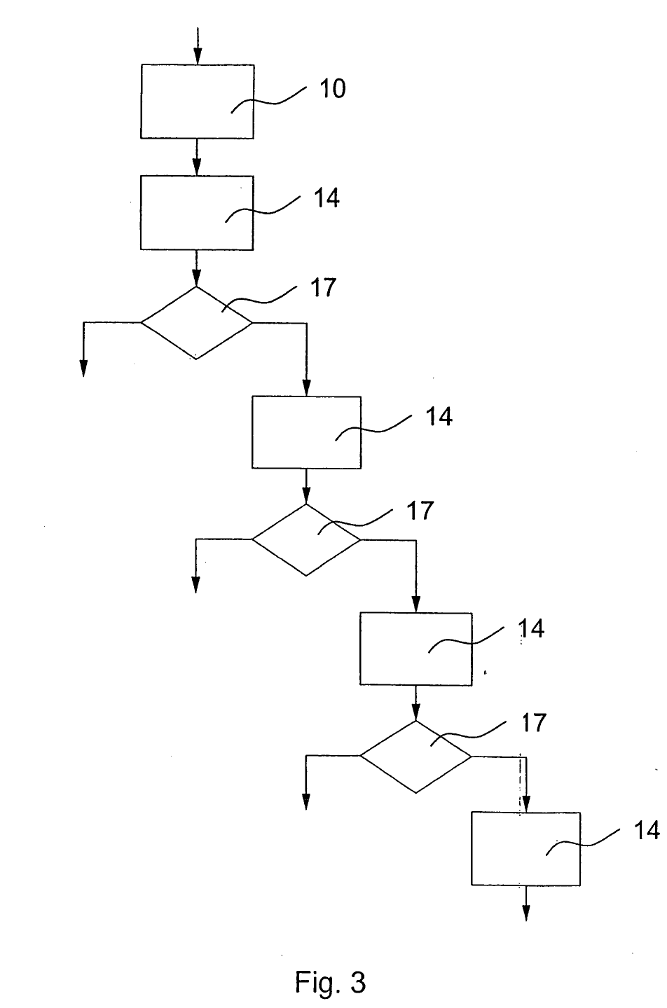

FIG. 3 cascading

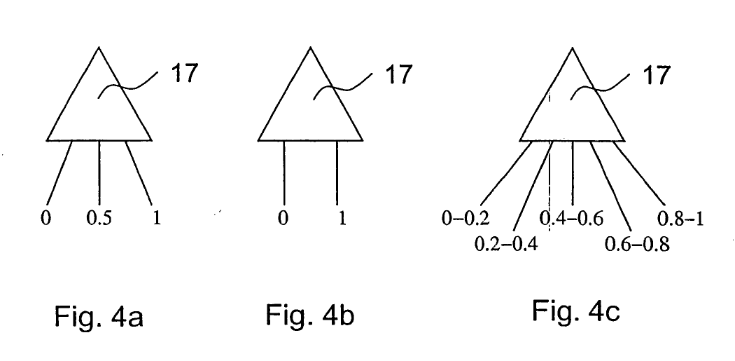

FIG. 4a-4c examples of selecting operations with various evalation criteria;

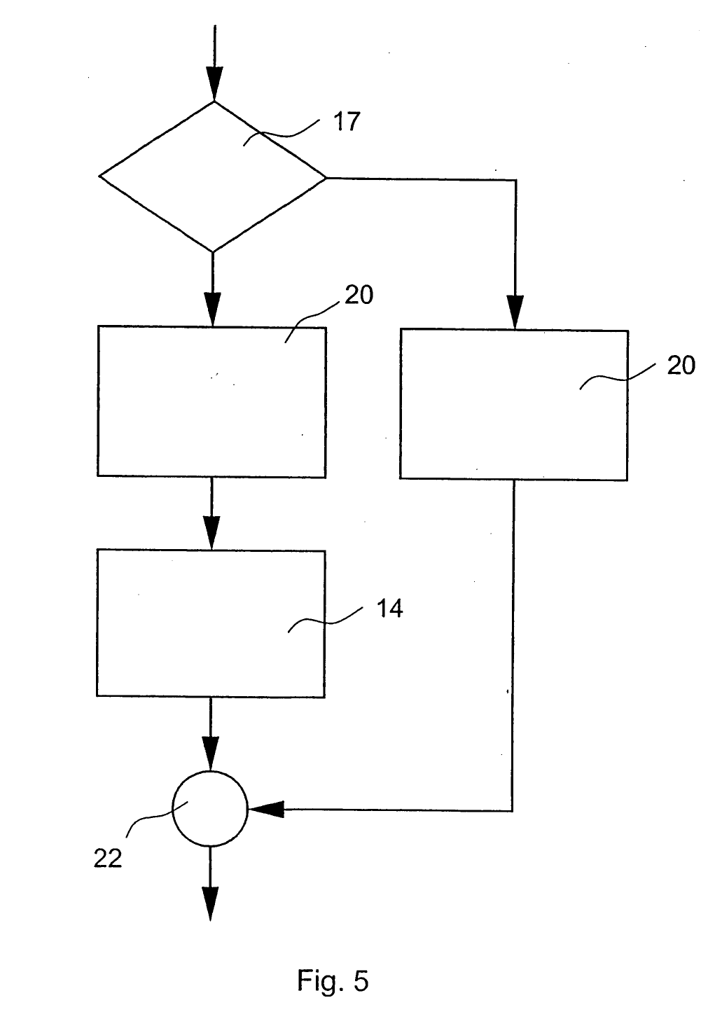

FIG. 5 IF-THEN-ELSE circuit of the steps or operations;

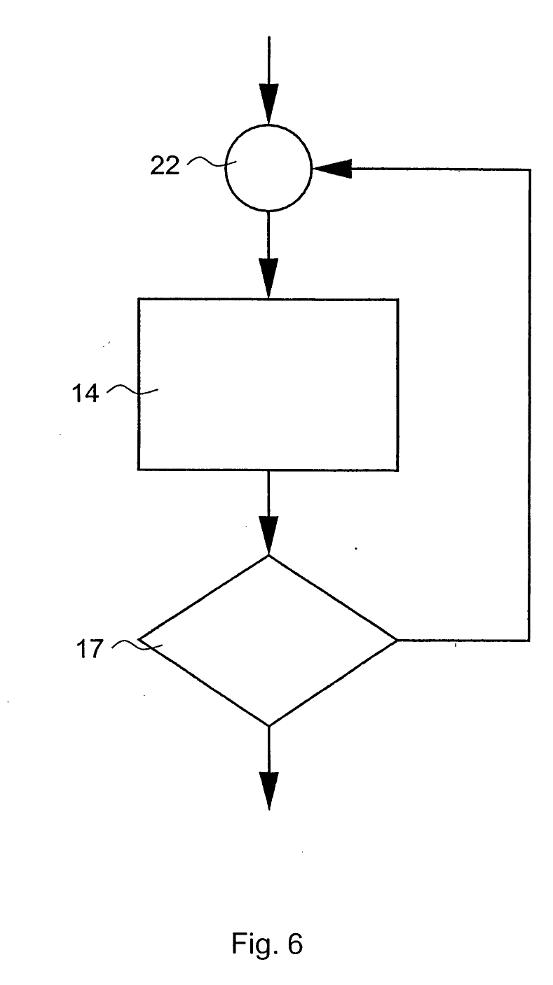

FIG. 6 REPEAT circuit of the steps or operations;

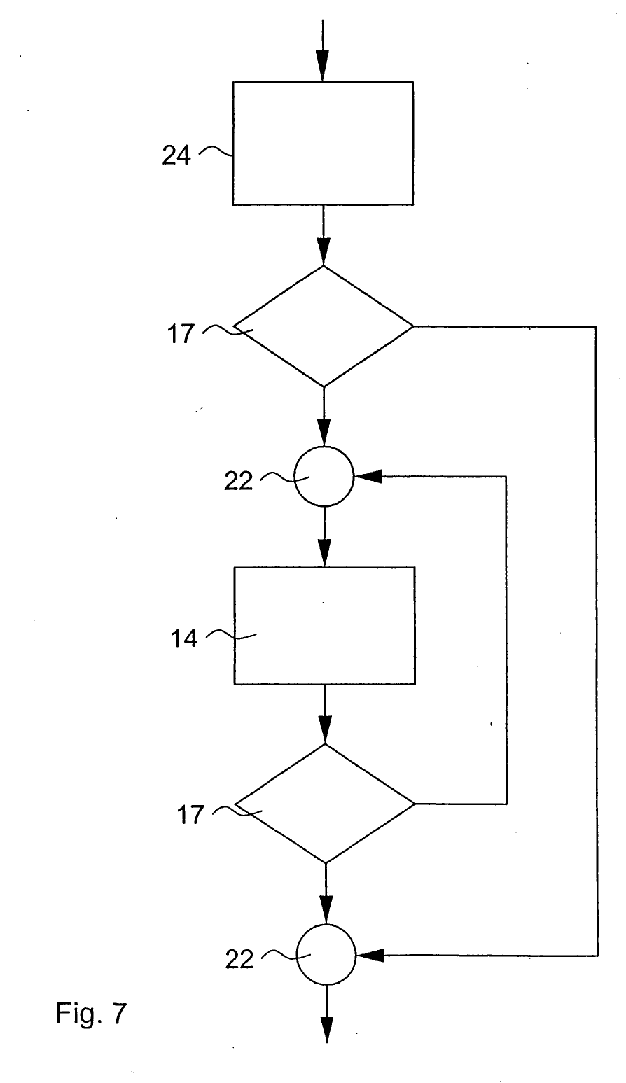

FIG. 7 WHILE-DO circuit of the steps or operations;

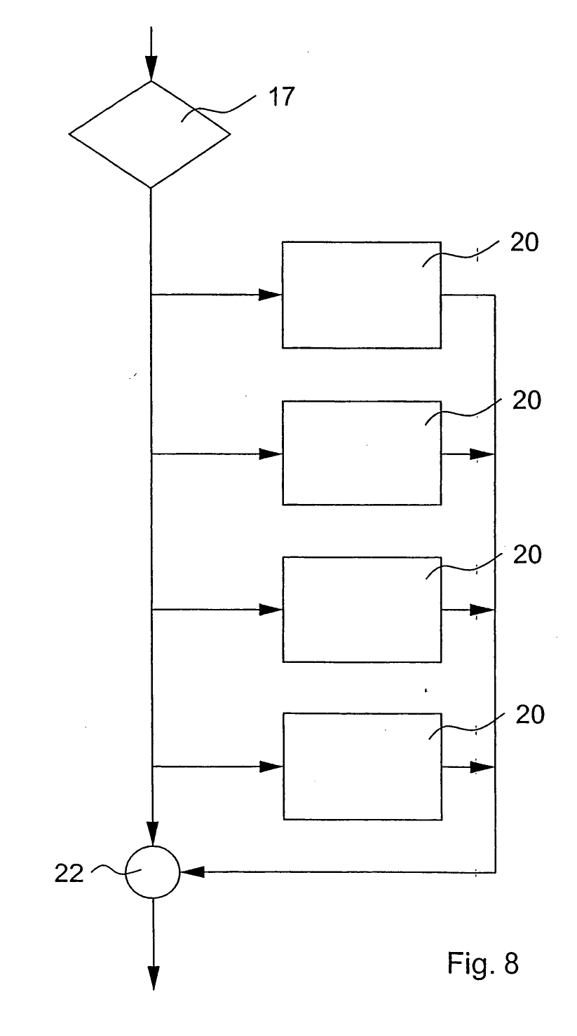

FIG. 8 CASE circuit of the steps or operations;

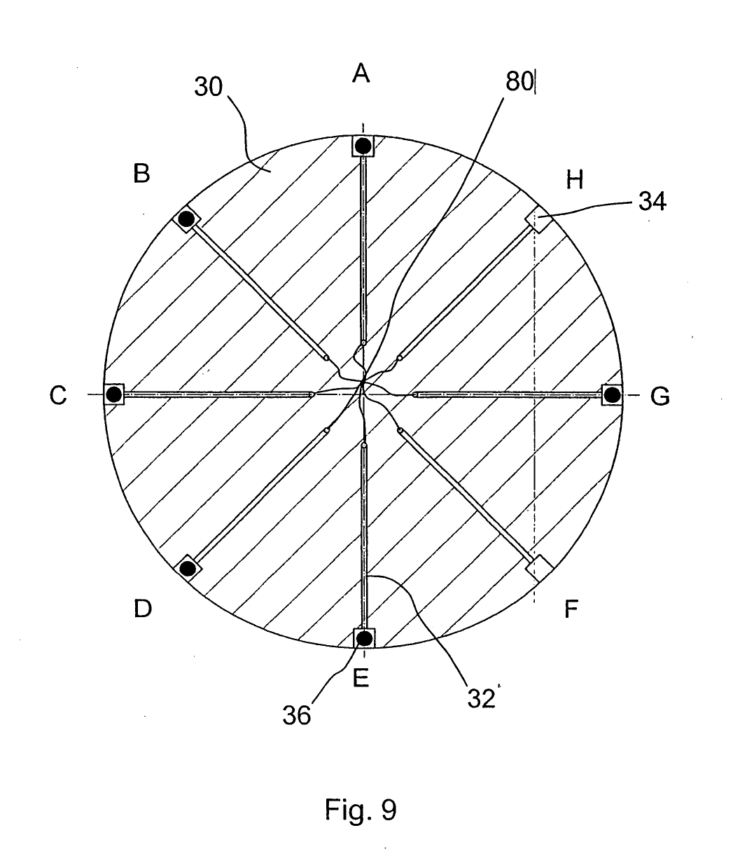

FIG. 9 circular device of a rotational single-bead reactor with radial fluid flow-through

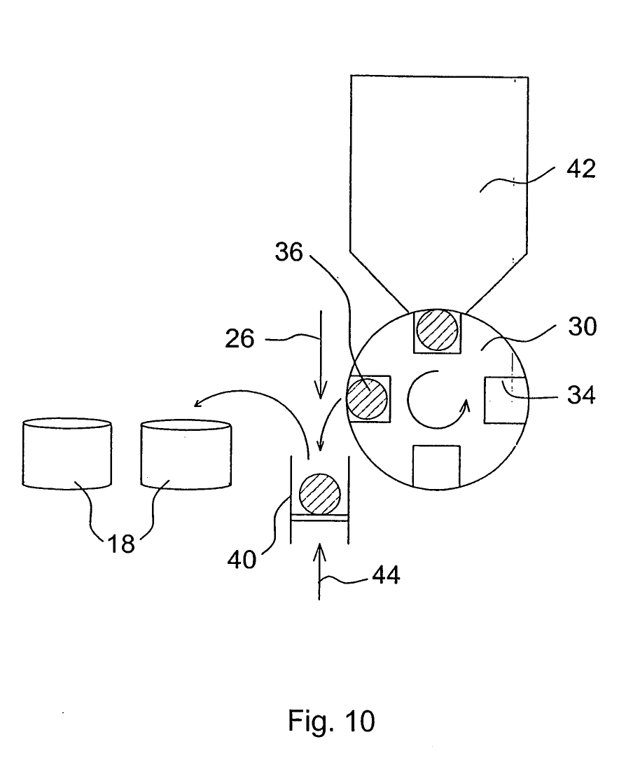

FIG. 10 pneumatic building block output from a tube;

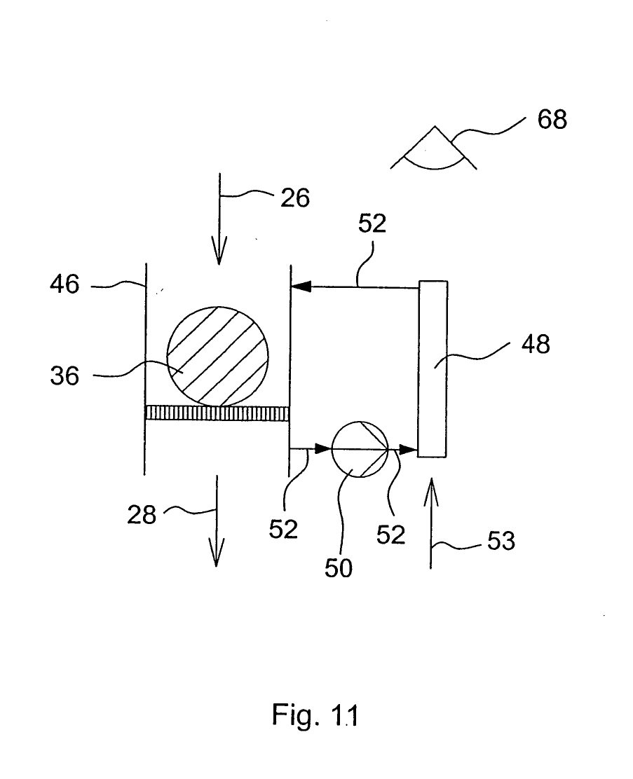

FIG. 11 individual building block within a differential recycling reactor with infrared analysis device;

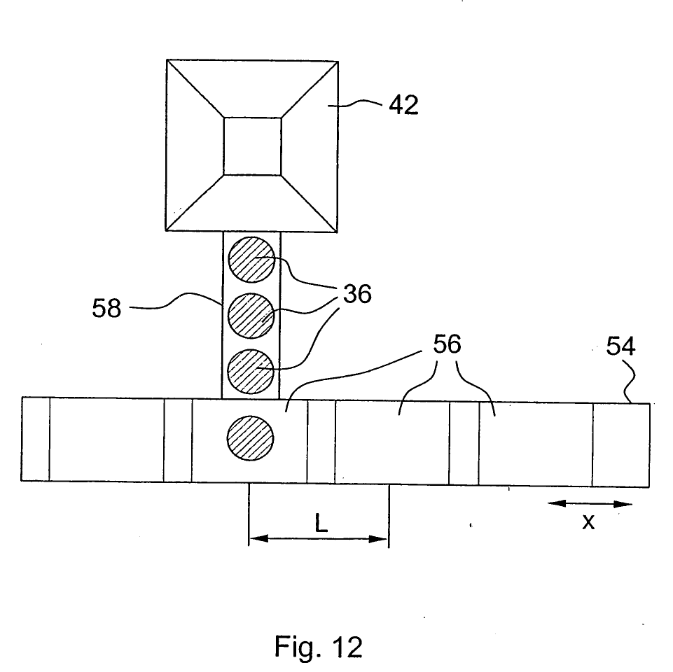

FIG. 12 comb or glider with one-dimensional operation mode;

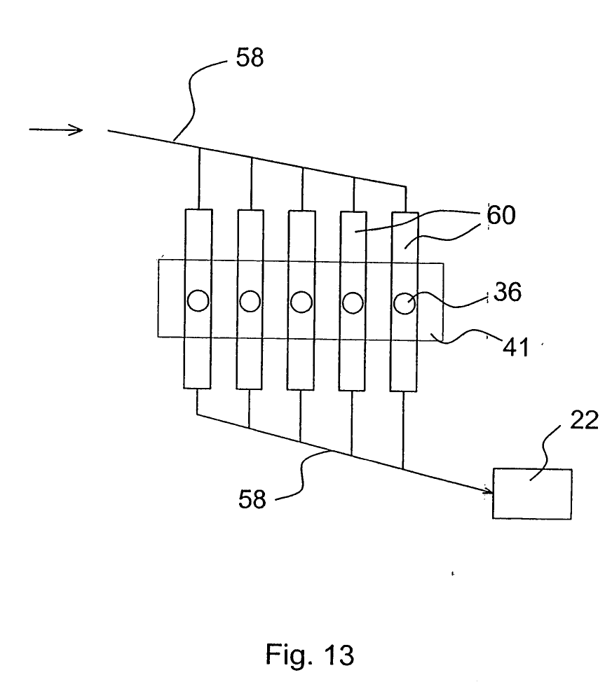

FIG. 13 parallel measuring assembly for the simultaneous determination of performance characteristics of 5 building blocks;

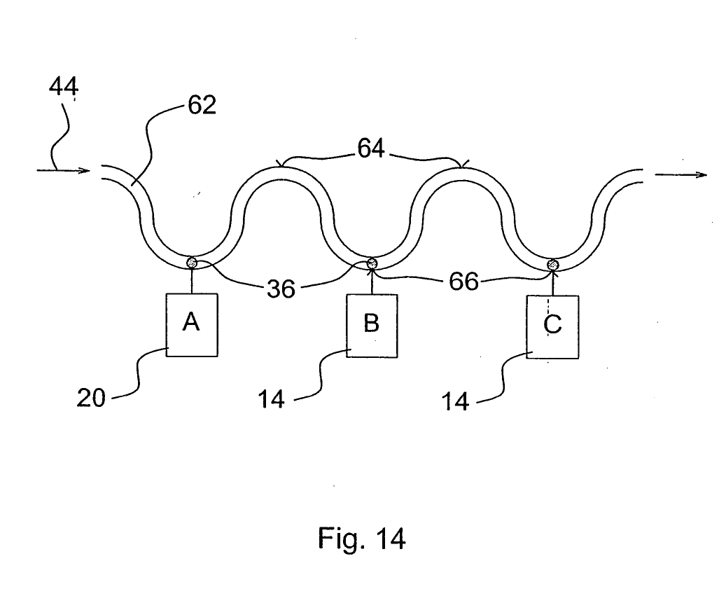

FIG. 14 wave-shaped assembly with stations for performing operations;

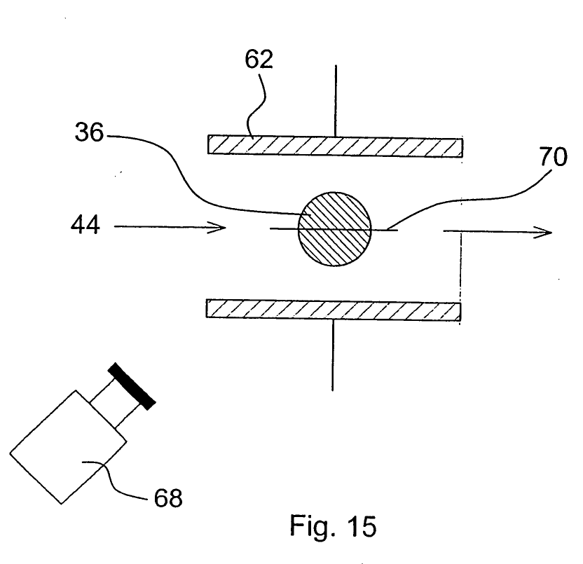

FIG. 15 performance of operations, e.g. a test operations, on one building block in the single-axis levitator;

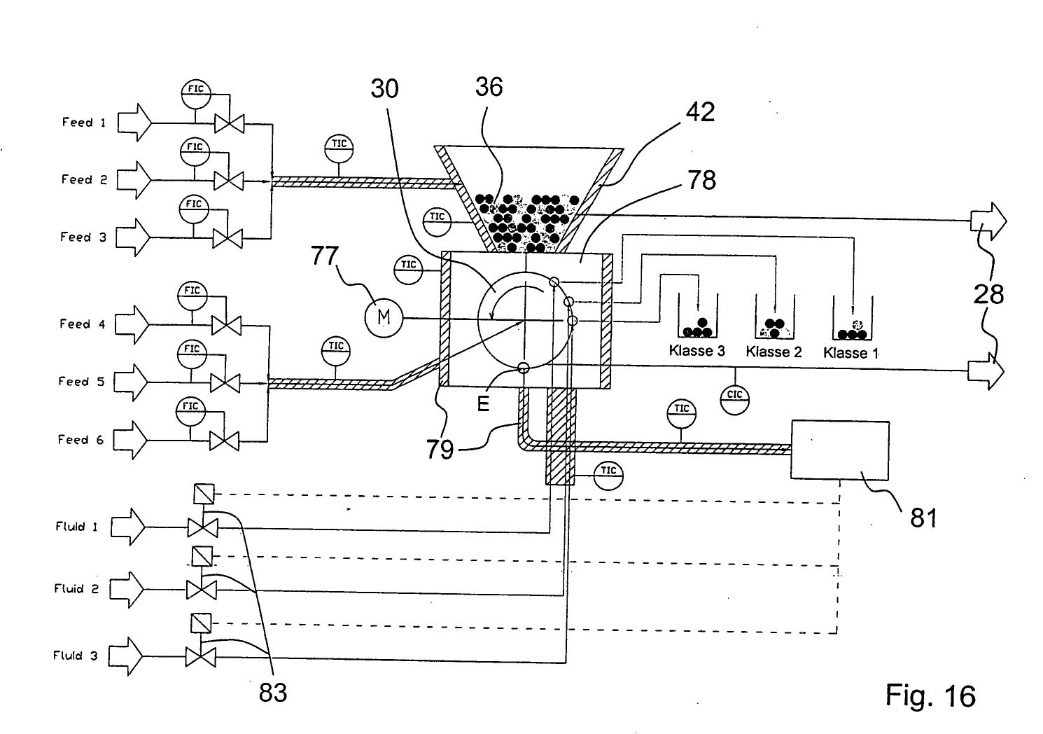

FIG. 16 inventive device with rotation-single-bead reactor;

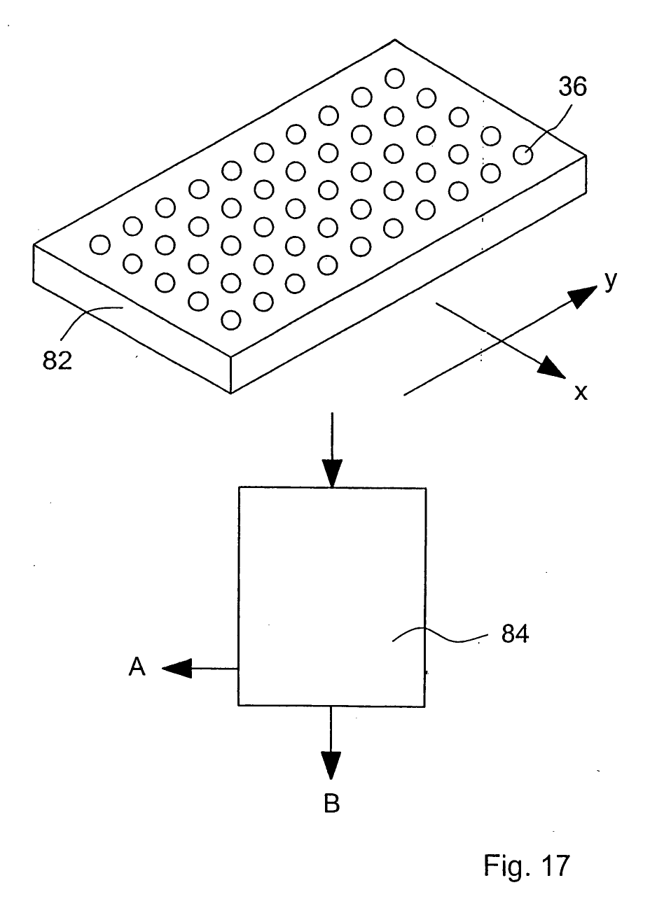

FIG. 17 possible embodiment for the transfer of the building blocks from a spatially coded building block assembly into the in entire device

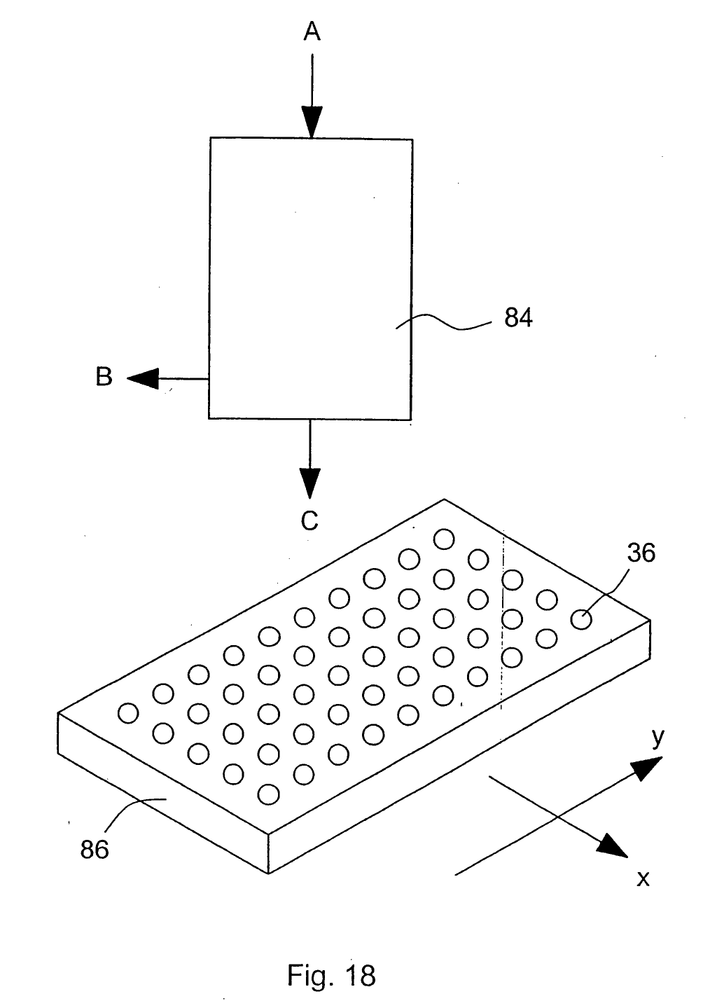

FIG. 18 possible embodiment for the transfer of the building blocks from the inventive device into a spatially coded building lock assembly;

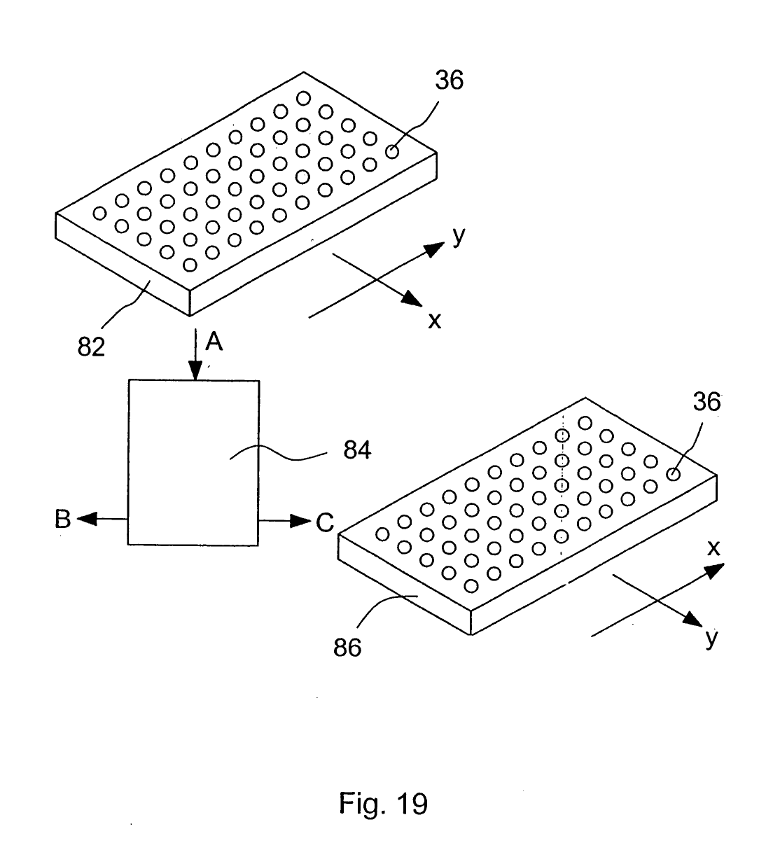

FIG. 19 possible embodiment for the transfer of building blocks from a spatially coded building block assembly into the device of the invention and back from there into another spatially coded building block assembly; and

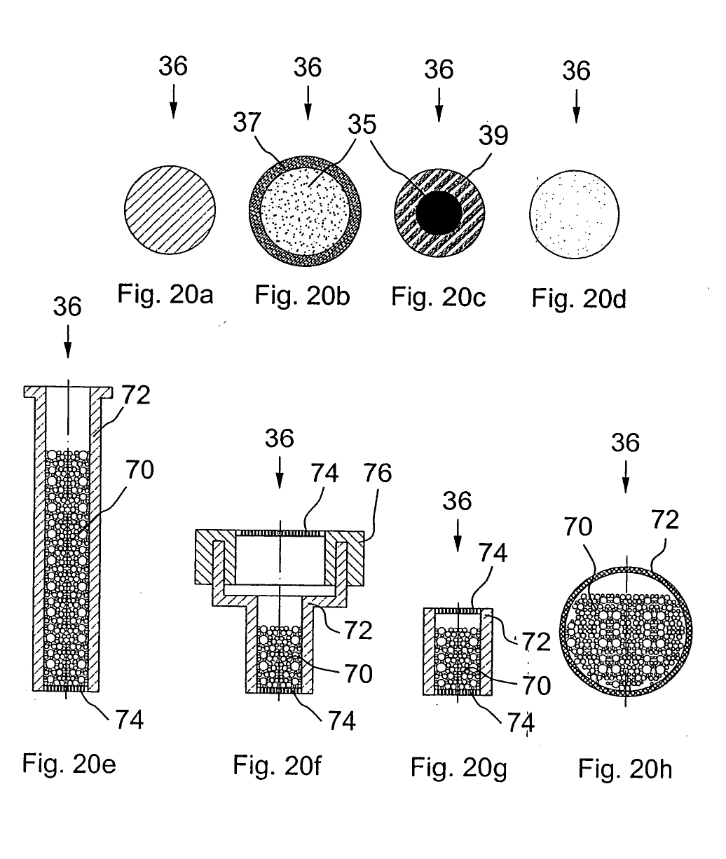

FIG. 20a-FIG. 20h examples of possible embodiments of building blocks.

FIG. 1 shows an example of a possible sequence of individual steps or operations of the method according to the invention. Therein, the individual blocks represent at least one step or one operation of the method according to the invention, wherein the arrows inbetween represent preferably at least one transport operation 12. A possible embodiment might include a transport operation 12 after a storing operation 10, subsequently a selecting operation 16, followed by a transport operation 12. Next, a conditioning operation 20 might be performed, followed by, e.g., a transport operation. Subsequently, an evaluation and classification 17 may determine by means of, e.g., a Yes/No decision, which building blocks are handed over to which following operation. In the present embodiment, e.g. building blocks with a positive test result are collected in a storing operation 10 and building blocks with a negative test result are handed over to further operations, e.g. a conditioning operation 20. The individual steps or operations may therein be arbitrarily combined corresponding to the desired process. Each block represented as one unit may also represent more than one identical or different internal operations with their own algorithm, respectively.

FIG. 2 shows a further embodiment of a process with a parallel sequence of the individual steps or operations. The individual blocks therein also represent preferably steps or operations or combinations of steps or operations of the method according to the invention. In this embodiment, e.g. the process is divided among, in this case, three parallel process lines after a storing operation 10 followed by a conditioning operation 20, e.g., integral conditioning. The sequence of the individual steps or operations are generally combinable as desired, however, in this embodiment, the steps/operations are preferably identical in each of the individual process lines in order to be able to test more building blocks per time unit. Within a process line, e.g. the test operation 14 may be performed after the conditioning operation 20, for example as an individual conditioning of the building blocks. Then, the building blocks are preferably subjected to an evaluation and classification operation 17, comparing the building blocks depending on the test result with evaluation criteria determined or please releasedeterminable during the process, e.g. in dependence of the test parameters, and are then handed over to various storing operations 10. The storing operations 10 may in turn be the starting point for steps or operations following thereto. Between the individual steps or operations, at least one transport operation 12 is preferably performed, represented by the arrows between the blocks in FIG. 2 as well as in FIGS. 3 to 8.

FIG. 3 shows a further embodiment of the combination of individual steps or operations, arranged in this case in cascade-shape. In this embodiment, the first test operation 14 preferably follows the storing operation 10, after which building blocks are chosen for the second test operation 14 by means of evaluation and classification 17. After the second test operation, the tested building blocks are again transfered to evaluation and classification 17 which in turn elects building blocks for the third test operation 14. This series may be arbitrarily extended, e.g. by means of a further evaluation and classification 17 after the third test operation 14, which chooses the building blocks for a fourth test operation 14 etc.

The aim of such cascading is on the one hand the possibility to test the building blocks for various properties and/or on the other hand the possibility to determine a performance characteristic more precisely wherein such cascading may also be performed within a device. The test speed may be identical or different on the individual levels of the cascade wherein the information depth of the testing be-comes preferably higher in deeper levels of the cascade; thus, the resting time per building block may also increase or the test speed may decrease. It may also be possible that storing operations 10 are performed between the various levels of a cascade which may e.g. serve as buffers for balancing the different test speeds. These intermediate storing operations 10 may therein be formed in such a way that the arrangement of the building blocks is effected arbitrarily or in order, i.e. geometrically identifiable.

FIGS. 4a to 4c represent an exemplary overview over possible evaluation criteria of an evaluation and classification operation 17. Therein, the kind and the number of evaluation criteria are generally not limited for each evaluation and classification operation 17.

FIG. 4a shows an evaluation and classification operation 17 with three evaluation criteria which have e.g. been chosen depending on specific results of test operations 14 (e.g. CO₂ content, product and/or educt concentration).

FIG. 4b shows an evaluation and classification operation 17 wherein the choice is between digital states 0 and 1, e.g. representing “good” and “bad”.

The evaluation and classification operation 17 of FIG. 4c shows in contrast to FIG. 4 two further evaluation criteria by means of which the evaluation range 0 to 1, which is identical for both evaluation operations, is further subdivided and thus enables an improved selection.

As described above, the steps or operations of the method of the invention may also be combined according to logical interconnections. FIG. 5 shows e.g. an IF-THEN-ELSE interconnection of steps or operations. Therein, it is possible, e.g. after an evaluation and classification operation 17, to additionally treat (conditioning operation 20) a part of the building blocks in order to prepare for the subsequent operations while the other part is individually prepared foil a test operation 14 in a conditioning operation 20.

Both partial sets may then be combined at an interconnection point 22 before they are transferred to further operations or collected in containers. Within the individual operations, logical interconnections are also possible. Additionally, e.g. pre-treatment or conditionings may be connected by means of loops in the sense of logical interconnections.

FIG. 6 shows a REPEAT interconnection wherein building blocks from an interconnection point 22 are transferred to a test operation 14, are then screened in accordance with the test result in an evaluation and classification operation 17 and are again transferred to the interconnection point 22 for again being subjected to a test operation 14 if the test results are insufficient.

FIG. 7 shows a WHILE-DO interconnection which may e.g. be used for coding of the building blocks. Subsequent to the coding 25, the building blocks are screened in an evaluation and classification operation 17 in accordance with the evaluation criterion “coding readable” or “coding illegible”. Building blocks, for which the coding was not recognized in the evaluation and classification operation 17, are transferred to another test operation 14, e.g. the examination of the coding, while an interconnection point 22 is provided prior to the test operation 13 into which those building blocks are returned that still have no readable coding after the test operation 14. There, they are tested again. The decision concerning the returning into the interconnection point 22 is again performed by an evaluation and classification operation 17 which is provided subsequently t˜ the test operation 14 wherein building blocks with illegible coding may be sorted out too after a predetermined number of returns. Subsequent to this evaluation and classification operation 17, the building blocks tested as readable are forwarded to another interconnection point 22. At this interconnection point 22, building blocks are also forwarded which have been chosen as building blocks with readable coding after the evaluation and classification operation 17 provided after the coding 24. The building blocks can be forwarded to other operations, e.g. evaluation and/or classification operations from this interconnection point 22, wherein those other operations are not represented in FIG. 7.

FIG. 8 shows a CASE interconnection subsequent to an evaluation and classification operation 17 which is exemplary for an evaluation and classification operation 17 shown in FIG. 4c. Therein, and in accordance with the number of evaluation criteria, e.g., conditioning operations 20 are provided subsequently to the evaluation and classification operation 20 in order to be returned to the part of building blocks, preferably in an interconnection point 22, in order to be for-warded subsequently to other operations, e.g. test operations 14.

The following figures refer in particular to the device in accordance with the invention.

FIG. 9 is a circular device 30 with channels 32 for a radial flow-through of the circular device 30, which is, e.g., in the shape of a flat plate, which is preferably part of a larger device, which in turn shows preferably fluid connections for fluid inlet and outlet. On the circumference (outside) of the circular device 30, recesses 34 are provided at the end of a channel 32. The recesses 34 are designed in such a way that preferably one building block 36 can be received therein.

The circular device 30 is preferably rotatable and is preferably rotated in a synchronized manner, wherein one turn corresponds exactly to the path on the circumference from one recess 34 to the adjacent recess 34. Thus, the filling of the circular device 30 with building blocks 36 via the respectively upper (position A) recess 34 is e.g. possible form a container/feed container (not shown in FIG. 9) by means of a transport operation 12. When displacing the circular device 30 in turns in anti-clockwise direction, e.g. a conditioning operation might be per-formed in position B, wherein the building blocks 36 are preheated. One turn on-wards, at position C, another conditioning operation 20 might be performed in which the building blocks 36 are brought to reaction temperature. Subsequently, the first test operation 14 could be performed at position D, the second test operation 14 e.g. at position E and the positions F, G and H could be used for discharging the building blocks 36 into collecting containers. Therein, e.g., an assignment of the respective evaluation criteria to one of the positions F, G and H respectively would be possible in such a way that the building blocks 36, tested as “good” are discharged from the circular device 30 into corresponding collecting containers at the position F, those tested as “medium” at positions C, and those tested as “bad” at position 0. The discharge of the building blocks 36 may be performed by applying a gas pressure specifically to the channel 32 of the circular device into which the corresponding recess 34 containing building block 36 to be discharged leads. The fluid connections 80 of the circular device 30 serve for fluid inlet, preferably reaction gas inlet, and may serve as a central reservoir for all channels 32 starting therefrom (not shown in FIG. 9) or may also be provided in a separated form in such a way that every channel 32 is connected to its own fluid inlet. In this case, every channel 32 could be flown through with another fluid or fluid mixture and/or with varying throughput. The flow direction if the gas can be directed as well from the fluid connections 80 via the channels 32 to the recesses 34 or also vice versa, wherein the fluid connections 80 would then serve as gas outlets. The circular device 30 is preferably equipped with cove 5 (not shown in FIG. 9) which may be made of various materials, depending on the analysis method, e.g., sapphire or silicon. Depending on its arrangement and its function, the method of the device may also be called a “rotation-single-bead reactor”. The covers not shown in FIG. 9 cover the preferably cylindrical circular device 30 on the base and/or cover surface.

In FIG. 10, the discharging of a building block 36 from a dosing wheel 30 (separation wheel) into a reaction chamber 40 is shown. After the test operation 14 performed in the reaction chamber 40, the building block 36 is preferably discharged from the reaction chamber 40 into the container 18 by means of a pneumatic pressure impulse 44. Therein, more than one identical or different container 18 may in turn be used, wherein every container 18 is provided for a certain evaluation criterion, e.g. a container 18 for building blocks 36 tested as “good” and a container 18 for building blocks 36 tested as “bad” in accordance with the evaluation criterion “good” or “bad” described before. The dosing wheel 31 has only four recesses 34 for receiving building blocks 36, in contrast to FIG. 9.

FIG. 11 shows a building block 36 in a differential circuit reactor 46 which is connected with an infrared analysis unit 48. When testing the building block 36, a part of or the entire amount of reaction gas 26 can be pumped into the infrared analysis unit 48 by means of a pump 50 and via connection elements 52, preferably tubular lines, and can be analyzed there. The reaction gas is preferably recycled to the differential circuit reactor 46 after testing and analysis.

The arrangement shown in FIG. 11 is an example for an IF-THEN-ELSE inter-connection of steps or operations. If, e.g. during the test operation 14, preferably by means of infrared thermography or mass spectroscopy a “good” measure result is found for the tested building block 36, in the differential circuit reactor 46, a part of the reaction gas may be transferred outside by means of the interconnection building blocks 52 and the pump 50 and into the infrared analysis unit 48 for further analysis. The arrow with reference number 53 represents electro-magnetic radiation which is preferably directed upon the infrared analysis unit 48.

The arrangement shown in FIG. 12 shows a “comb” or glider 54 for receiving preferably one building block 36 which is received by one of the receivers 54 and is displaceable, preferably linearly in x-direction, for performing further steps or operations by means of the glider 54. The displaceability of the glider 54 by a length preferably corresponding to the distance between the recesses 56 or a multiple thereof allows for the positioning of the building block 36 at determined locations in order to perform operations, e.g. test operations. Therein, every position, preferably, corresponds to the location for performing at least one of the afore-described operations. The filling of the glider 54 with building blocks 36 is effected via a feed container 42 and a conveyor device 58, preferably provided underneath the preferably funnel-shaped feed container 42 e.g. in the form of a conveyor band, in such a way that the building blocks 36 which may be dosed onto the conveyor device 58 from the feed container 42 are transported to the recesses 56 of the glider 54 by means of the conveyor device 58. At the end of the conveyor device 58, preferably, one building block 36 falls into the recess 56 of the glider 54, provided underneath. Generally, the filling of the recesses 56 with more than one building blocks 36 per recess 56 is also possible, as well as the filling of all recesses 56 of the glider 54. Even more than one feed container 42 with, e.g., building blocks 36 having different pretreatment wit one conveyor device 58 each for transporting the building blocks 36 into the recesses 56 of the glider 54 may be provided. At least one conveyor device 58 per feed container 42, when using more than one feed container 42, may also be replaced by a displace-able conveyor device 58, wherein the method may be a linear displacement, a three-dimensional positioning, a distortion or a swiveling. The glider 54 may, e.g., also be provided as a displaceable band having freely selectable shapes (e.g. linear or circular) or have the shape of a wheel.

FIG. 13 shows a parallel arrangement of e.g. five reaction chambers 60, preferably made of infrared-transparent material and/or with connections for analysis by means of PAS pipes (reference is made to DE-A 10004816.1 for more detailed explanation of PAS pipes) which preferably serve for testing the building blocks 36 in a test operation. The filling of the reaction chambers 60 with building blocks 36 may in turn be performed by means of a conveyor device 58. Also this embodiment provides preferably only one building block per reaction chamber 60. The transport of the building blocks 36 to, e.g., a next module, e.g., an interconnection point 22, is herein preferably performed by a conveyor device 58 after the performed testing in the reaction chamber 60. In accordance with the test results more than one interconnection point (not shown in FIG. 13) may be provided, e.g., for building blocks 36 tested “good” or “bad”.

The wave arrangement shown in FIG. 14, preferably a tubular system 62, shows a further possibility of transporting the building blocks 36 from one operation to the next. Preferably, every one of the positions A, B, and C is one stop or one operation of the method of the invention, e.g., a conditioning operation 20 at position A, a first test operation 14 at position B, and a second test operation 14 at position C. The transport of the building blocks 36 within the tubular system 62 may be effected by means of a directed pneumatic pressure impulse 44, preferably supported by devices such as flaps and valves, wherein the strength of the pressure impulse 44 is always adjustable exactly in such a way that the building blocks 36 surpass one wave crest 64 per directed pneumatic pressure impulse 44 and settle down again in the subsequent wave trough 66, i.e. are transported from one wave trough 66 to the next. Within the tubular system 62, further components, such as valves or branchings (e.g. forkings) may be provided in order to transport the building blocks, e.g., after a test operation 14, according to the test result to further treatments or further tests.

FIG. 15 shows an embodiment for the contact-free performance of an operation, e.g. a test operation, on a building block 36 e.g. in a tubular system 62, by means of a single-axis levitator. Therein, the building block 36 is preferably held in levitation by means of a field of force which is created by the single-axis levitator without contacting the walls of the tubular system 62, preferably on a position on the longitudinal axis 70 of the tubular system 62 defined by a central point of the field of force. The transport of the building blocks is herein also effected preferably via a pneumatic pressure impulse 44. The streaming over of a building block 35 within the levitator is also preferably performed in the direction of the longitudinal axis 70.

Alternatively or also in combination with a single-axis levitator, a multi-axis, preferably three-axis levitator, may be used.

The advantages of such contact-free testing of the building blocks 36 are on the one hand that in particular in testing (infrared analysis), no outside-heat influence by, e.g., direct contacting of the building block 36 with the walls, occurs and that on the other hand, there is less to no rubbing off of the building blocks 36 by contact with the walls. The test position is always the same which is in also advantageous in particular in view of the redundance of adjusting of the measuring apparatuses.

A levitator is a device in which a field of force is created in order to keep individual drops or individual particles in levitation without contact. Aerodynamic, electrostatic, electromagnetic and acoustical levitators are known. In special embodiments, fields of force with more than one axis, e.g. three axis, can be created in order to increase the stability of the positioning of the drop or particle as well as in !order to achieve a more constant actuation of the force to the drop or particle.

FIG. 16 schematically shows an embodiment of the inventive device with a rotation-single-bead reactor 78. Therein, the building blocks 36 of a library of materials are stored in a feed container 42 (storing operation) and are already defined in this feed container 42, e.g. from bottom to top, flown over with a fluid mixture (defined combination of feed 1, feed 2 and feed 3). This realizes a conditioning operation simultaneously to the storing operation. The feed container 42 is performed also definably tempered like the fluid inlet. The inventive material test is effected in the rotation-single-bead reactor 78, provided underneath the feed container 42. By rotating the circular device 30 of the reactor 78, exactly one building block 36 is forwarded with every turn into the recess 34 of the well provided therefore (cf. referring to the recesses 34 FIG. 9). This geometrical-mechanical arrangement realizes a selecting operation. The synchronized turning of the circular device 30 by means of a motor 77 (transport operation) places the building blocks 36 one after the other into positions in which another conditioning operation is performed, now with a fluid mixture, which is combined from feed 4, feed 5, and feed 6. In another position E of the circular device 30 (FIG. 16, schematically shown at the bottom of the circular device 30), a test operation is performed wherein the building block 36 to be tested is flown over with the same fluid mixture as in the previous conditioning operation. The fluid flowing off building block 36 is guided completely or partially to an analysis device 81 which per-forms an analysis for performance characteristics, e.g. the determination of the catalytic activity and the catalytic selectivity. In order to set a certain parameter set P for the test operation, the reactor 78 can e.g. be tempered by means of a heating device 79. Moreover, setting a desired pressure is possible (not shown in FIG. 16) The measurements detected with the analysis device 71 for one building block are electronically handed over to a control/regulation calculator (also not shown in FIG. 16), in which by means of the appropriate software, an evaluation of the measurement is performed with one or more threshold values (evaluation operation). The result of the evaluation operation then shows td which class a building block 36 is to be assigned. This classification is subsequently performed pneumatically by means of the fluids 1, 2 and 3 (classification operation). If a building block 36 is to be assigned to the class 3, a magnet valve 83 provides a pressure pulse (pressure impulse) onto the corresponding position of the wheel as soon as the building block 36 is provided in this position in accordance with the synchronized rotation of the circular device 30. This process is preferably per-formed in an electronically controlled manner. Analogously, the assignment of a building block 36 to the class 2 is performed wherein the pneumatic pressure impulse is caused with fluid 2, again switched by means of a magnetic valve 83. All remaining building blocks 36 are then removed by fluid 1 and assigned to class 1. The fluid inlets for classification can also be kept at a temperature in order to avoid undesired thermal influence of the reactor 78 by the fluids.

FIG. 17 shows that the testing of the building blocks 36 for performance characteristics may be effected by an array 82. This has the advantage that the building blocks 36 then have a geometric coding, in contrast to the performance of the method based on a subordinate building block arrangement, the coding of which allows the assignment of the test values directly for the further information concerning the building blocks 36, e.g. via the sequence of the production of the building blocks 36. Preferably, the array 82 can be positioned in X-Y direction in order to forward the building blocks 36 in sequence to the inventive device 84 for performing the inventive process. Alternatively, it is possible to use an automated picker or robot, transferring the individual building blocks 36 or several building blocks 36 in order from the array 82 into the device 84 of the invention. In a preferred embodiment, the building blocks 36 are subjected to a conditioning operation in the array 82 as this can be achieved, e.g., by means of the device described in DE-A 10117275.3. In FIG. 17, the building blocks 36 are sorted into two classes corresponding to their test result, characterized by the different outlets A and B.

Another embodiment is shown in FIG. 18. Herein, the inventive device 84 pep forms a continuous testing of the building blocks 36 for performance characteristics in the sense of the present invention. Therein the building blocks 36 are classified into two classes B and C, corresponding to their properties. Building blocks 36, fulfilling the requirements, i.e. having a certain property or a certain quality of a property, are sorted into class C. The building blocks are, however, not removed into a simple collecting container, but into an array 82, which allows for a defined filling of building blocks 36 in accordance with their geometrical position in the array 82. Thus, a certain test result can subsequently be assigned via this geometric coding to exactly one building block 36, and this or these building block(s) 36 can e.g. be subjected to a post-characterization or a renewed run of the method of the invention, e.g. corresponding to FIG. 17, however with a changed parameter set P.

Preferably, the array 86 can be positioned in X-Y direction in order to achieve the filling of the building blocks 36. Alternatively, positionable pickers or robots can be chosen.

In a preferred embodiment, the target array 86 is therein provided as described in DE-A 10117275.3. Building blocks 36, tested positively in an algorithms corresponding to the present method, can thus be subjected in further examinations to a method according to the one of DE-A 10117274.5 which leads to the further, intensified examination of potential materials, e.g. over a longer period of time. The inventive method thus fulfills the function of a pre-testing or a pre-sorting of potential materials in a high throughput work process.

In another embodiment of the method of the invention, the array 86 mentioned above can also be a device as per DE-A 19809477.9 or DE-A 10036633.3. These arrays are preferably used if the building blocks to be tested are provided in defined containers which may further be processed directly in the above-mentioned arrays.

In another preferred embodiment (FIG. 19), the embodiments of FIGS. 17 and 18 are combined in order to achieve another additional usage, i.e. the assignment of the building block 36 to the test result of the building block 36 and/or to the properties of the building block 36 prior to the test as well as subsequently. Additionally, it is also possible to sort the materials sorted out via class 13 into an array. The same applies for further potential outlets or classes of the inventive device 84 of the inventive method.

In FIGS. 20a to 20h, various kinds and embodiments of possible building blocks 36 are shown.

FIG. 20a: Herein, the building block 36 is a building block which is provided in a defined geometrical shape e.g. a bead. Of course, other geometrical shapes are also possible, e.g. prism, cylinder, hollow cylinder, hollow ball, pyramid, block, rotation paraboloid, ellipsoid, cone or any other conceivable rotation bodies. In a preferred embodiment of FIG. 20a, a carrier material is used as the bead, e.g. a porous or unporous ceramics. If this carrier material is porous, further materials can be added in the pores of the material, such as is the case in he synthesis of typical carrier catalysts by means of impregnation. In a particularly preferred embodiment, the building block of FIG. 20a is thus a typical carrier catalyst (=supported catalyst) in bead-shape.

FIG. 20b: In another embodiment, it is possible that this building block 36 consists of a core 35 and at least one shell 37 around this core 35. In a preferred embodiment, the core 35 is an inert material, serving as carrier for the potentially active substance. Such building blocks 36 are produced by covering cores 35, which are present in a defined geometrical shape. In a preferred embodiment, such a building block 36 is a shell catalyst. The core in this case is preferably an inert chemical material onto which a catalytically active material has been coated by means of a coating method or a certain synthesis process.

FIG. 20c; In this embodiment, the core 35 of the building block 36 consists of a material, which displays a certain, preferably physical, property, which, however, is inert in the test operation to be performed or is protected against the attack of fluids etc. This core 35 may e.g. be a magnetic core, so that a transport, the handling or selection of such a building block 36 is made possible by the defined use of a magnetic field. On this core, a layer 39 is preferably deposited, isolating the core 35 against further layers. Outer layers are then, e.g., embodiments as per FIG. 20b or FIG. 20a.

FIG. 20d: In this embodiment, the building block 36 is not supported, e.g., a full-body catalyst which may be represented in a defined geometrical shape by using corresponding methods. In another embodiment, the building block 36 may also have a hollow core.

FIG. 20e: For the testing of powder materials, the building blocks 36 may also be provided in a shape showing FIG. 20e. Therein, a powder 79 is provided in a casing 72, wherein the powder 70 lays on a flit or membrane 74 at the bottom of the casing 72, which avoids a downwards leaking of the powder 70. The flit or membrane 74 can also serve as a permeable medium with respect to fluids in accordance with the invention, which allows the examination of a performance property of the powder material when exposed to fluids using a parameter set P. In this embodiment, the casing 72 is preferably open at the upper end, in order to fill in the powder. This entails that the building block 36 has to be kept in such a position during the test that the powder cannot leak accidentally. In another embodiment, the casing may contain further flits or membranes 74 (not only at the bottom of the casing 72) or may consist completely of a fluid-permeable material.

FIG. 20f: In comparison to FIG. 20e, FIG. 20f shows a building block 36, the casing 72 of which may be closed by a resealable cover 76 after filling-in of the powder 70. A fluid permeable frit or membrane 74 is also provided in the cover 76 which is shaped in such a way that the powder 70 is kept from leaking. In another embodiment, the casing 72 as well as the cover 76 may comprise further fits or membranes 74 or may also consist completely of a fluid-permeable material.

FIG. 20g: FIG. 20g shows a building block 36, containing one, preferably two fluid-permeable frits or membranes 74 wherein this building block 36 is tightly sealed so that the powder 70 contained therein cannot leak. The powder 70 is thus either filled into the still open casing 72 and this casing is subsequently tightly sealed by means of substances or other means, e.g., by bonding, or the powder is directly synthesized within the casing from its fluid phase. In another embodiment, the casing 72 may comprise further frits or membranes 74 or may consist completely of a fluid-permeable material.

FIG. 20h: A special embodiment of the building block 36 of FIG. 20g is shown in FIG. 20h. Herein, the entire casing 72 consists of a fluid-permeable membrane. In this casing 72, the powder 70 is locked. The production of such a building block 36 is preferably effected in such a way that a powder 70 is formed into a solid body with a matrix template material, e.g., graphite, and that a porous, consistent membrane is subsequently synthesized onto this solid body. In a subsequent thermal treatment, the matrix template material is burned, so that the casing 72 and the powder 70 remain. In another embodiment, a highly porous shaped body which consists e.g. of graphite, is sturated with various precursor solutions, e.g., by means of the method described in DE-A 10059890.0. Subsequently, a porous membrane is synthesized onto this body. In a thermal treatment, the material of the shaped body is removed; the casing 72 as well as a finely grained powder 70 remain from the synthesis in the pores of the shaped body.

Generally, the building blocks 36 of FIG. 20 are shaped in such a way that they may contain a coding which allows an unambiguous identification of the building block 36 as well as tracking its path in a synthesis and/or test method of the present invention. For further details with regard to production and use of such coding it is referred to the corresponding descriptions in DE-A 10117275.3 and DR-A 10117274.5

In particular, the building blocks 36 of FIGS. 20e to 20h can show means for the tracking of positions wherein the coding can also be used as a means for the tracking of positions or position identification of the building blocks 36, it is referred in the entire extent to the explanations given in DE-A 10117274.5 and DE-A 10117275.3 wherein both applications are to be included in this respect into the context of the present application.

A preferred embodiment will be explained in more detail by means of the following example.

### EXAMPLE

First, all aqueous impregnation solutions used in the example (syl˜thesis of build-ing blocks) are listed (concentrations and volume):

| Precursor | ratio | molarity | vo1ume |
|---|---|---|---|
| V2(C₂H₄0₄)₅/H₃PO₄ | (1:1) | 0.5M | 1000 μl |
| Ni(NO₃)₃ | | 2M | 500 μl |
| Co(N0₃)₃ | | 3M | 500 μl |
| Mg(NO₃)₂ | | 2.85M | 1000 μl |
| Cr(No₃)₃ | | 1.4M | 500 μl |
| Rh(NO₃)₃ | | 1.25M | 1000 μl |
| AgNO₃ | | 2M | 1000 μl |

In a first step, 500 μl V solution are added to 1 g γ-aluminum oxide beads (CONDEA, 1 mm diameter, ca. 0.7 g weight per bead) in a porcelain bowl, in a first step (1^{st} generation) by pipetting evenly over the surface. After drying (2 h at 80° C. in the drying oven) and intensive mixing, the amount is divided in half and transferred into two new intensive mixing, **the amount is divided in half and transferred into two new porcelain bowls; the first half 9 into two new porcelain bowls; the first half of bowls is impregnated with cobalt solution (=2^{nd} generation V—Co, the second half with nickel solution (=2^{nd} generation V—Ni). In new bowls, both sets of the second generation are united, mixed and impregnated with magnesium solution (3^{rd} generation V—CO—Ni—Mg) after drying (2 h at 80° C. in the drying oven). Subsequently, the carrier bodies are dried (2 h at 80° C. in the drying oven), divided in half again, and distributed onto two bowls; one half is impregnated with a rhodium precursor solution (4^{th} generation V—Co—Ni—Mg—Rh), the second one with the chromium solution (=4^{th} generation V—Co—Ni—Mg—Cr). Both sets are again dried and pooled again, intensively mixed and, in the last step, impregnated with the silver solution (=final generation V—Co—Ni—Mg—Rh—Cr—Ag). Finally, a further drying step is per-formed: the final generation is treated for 12 h at 80° C. in a drying oven and is calcined at 500° C. under nitrogen in a convection oven.

After calcination, all building blocks (beads) 36 are transferred in to the feed (storage) container 42 (FIG. 16). While storing, the entire library of materials is kept at 200° C. under a N₂ flow of 200 ml/min. The circular device 30 of FIG. 9 with e.g. 8 positions A-H successively receives beads (building blocks 36) from the storing container 42. On the first position A of the well, a fluid flows in from the fluid inlet 8 connected with the position A via a channel 32. Here, the bead (building block 36) is flown over by N₂ (2 ml/min, 350° C.) and is heated. Position A however alternatively allows for sucking the bead (building block 36) from the feed container 42 by means of low pressure (membrane pump) to position A in the circular device 30. By rotating the circular device 30 by 45° (duration of the turn: 10 s), the bead (building block 36) arrives at the conditioning positions B to D. Here, the beads are flown over with a flow of 2 ml/min with a fluid mixture (1% toluene in synthetic air) via the fluid connections 80 (FIG. 9) connected to these positions at 350° C. During further rotating the circular device 30, position A of the whell is filled with the next bead (building block 36). The target reaction is the partial oxidation of toluene to benzaldehyde in the gas phase with synthetic air. Position E is the measuring position of the circular device 30, the measuring is performed under the analogous conditions as at the conditioning positions B-D, by means of mass-spectroscopy analysis (FIG. 16, reference 81). A commercially available mass spectrometer with sample capillary (“Schnüffelleitung” Balzers QMS 200) analyzes the fluid or product flow from the measuring position within 7 s. Based on the ion flow for chosen m/z ratios, the choice of the materials is effected on the classification positions F-H. By way of example, three products with corresponding m/z ratios were chosen: m/z=44 characteristic for CO₂, m/z=106 characteristic for benzaldehyde and m/z=123 characteristic for the benzene acid. On position F (FIG. 9) those beads are discharged, that are of value for the target reaction (toluene to benzaldehyde) i.e. have a value exceeding 5*10¹¹ mA for m/z=106. On position G of the circular device 30 (FIG. 9) all materials (building blocks 36) are sorted out which have a CO₂ (mlz=44) signal higher than 2*10⁷ mA, i.e. they mainly burn the toluene completely or which have a higher value for the signal for benzene acids of 1*10⁻¹⁰ mA of the peak at m/z=123. At the last position all remaining beads (building blocks 36) are “collected”. These beads (building blocks 36) have neither a significant activity for the target product nor to CO₂ under these conditions. Subsequent to this evaluation of the materials, the building blocks 36 are characterized corresponding to their performance characteristics (catalytic activity and catalytic selectivity), at position F by building blockary analysis by means of XRF. The result shown in the following Table 1 represents 10 materials (building blocks 36) of class F, creating benzaldehyde over a certain threshold value (m/z=1 06>5*10¹¹ mA):

TABLE 1
Results of the μ-EDX on 10 materials (building blocks 36) of class F.
Final generation: V—Co—Ni—MG—Rh—Cr—Ag

| | Oxide | Wt % |
|---|---|---|
| 1^{st} bead (building block 36) | Al | 92.33 |
| | V | 2.5 |
| | Co | 0.23 |
| | Ni | 1.78 |
| | Mg | 0.96 |
| | Rh | 0.77 |
| | Cr | 0.74 |
| | Ag | 0.33 |
| 2^{nd} bead (building block 36) | Al | 91.88 |
| | V | 2.13 |
| | Co | 0.44 |
| | Ni | 1.46 |
| | Mg | 1.78 |
| | Rh | 0.71 |
| | Cr | 1.98 |
| | Ag | 0.01 |
| 3^{rd} bead (building block 36) | Al | 96.10 |
| | V | 1.99 |
| | Co | 0.53 |
| | Ni | 1.22 |
| | Mg | 1.62 |
| | Rh | 0.64 |
| | Cr | 2.13 |
| | Ag | 0.05 |
| 4^{th} bead (building block 36) | Al | 97.39 |
| | V | 1.31 |
| | Co | 0.3 |
| | Ni | 1.54 |
| | Mg | 1.34 |
| | Rh | 0.39 |
| | Cr | 1.02 |
| | Ag | 0.11 |
| 5^{th} bead (building block 36) | Al | 92.99 |
| | V | 2.19 |
| | Co | 0.71 |
| | Ni | 0.63 |
| | Mg | 1.14 |
| | Rh | 0.57 |
| | Cr | 1.83 |
| | Ag | 0 |
| 6^{th} bead (building block 36) | Al | 95.99 |
| | V | 1.85 |
| | Co | 0.47 |
| | Ni | 0.65 |
| | Mg | 1.95 |
| | Rh | 0.66 |
| | Cr | 0.61 |
| | Ag | 0.23 |
| 9^{th} bead (building block 36) | Al | 97.18 |
| | V | 1.14 |
| | Co | 0.41 |
| | Ni | 1.26 |
| | Mg | 0.26 |
| | Rh | 0.34 |
| | Cr | 0.81 |
| | Ag | 0.13 |
| 10^{th} bead (building block 36) | Al | 97.65 |
| | V | 1.33 |
| | Co | 0.61 |
| | Ni | 0.34 |
| | Mg | 0.76 |
| | Rh | 0.43 |
| | Cr | 0.19 |
| | Ag | 0.07 |

List of References
10—storing operation
12—transport operation
14—test operation
16—selecting operation
17—evaluation and classification operation
18—container
20—conditioning operation
22—interconnection point
24—coding
26—reaction gas
28—waste gas
30—circular device
31—dosing wheel
32—channel
34—recess
35—core
36—building block
37—shell
38—central hollow space
39—coating
40—reaction chamber
41—infrared transparent window
42—feed container
44—pneumatic pressure impulse
46—differential circuit reactor
50—pump
52—connection building block
53—radiation
54—glider
56—receiver
58—conveyor device
60—reaction chamber
62—tubular system
64—wave crest
66—wave trough
68—analysis facility
70—powder
72—casing
74—membrane
76—cover
77—motor
78—rotation single bead reactor
79—heating
80—fluid connection
81—analysis device
82—array
83—magnetic valve
84—device of the invention
86—array
FIC—Flow Indication Control
TIC—Temperature Indication Control
CIC—Concentration Indication Control

1-39. (canceled)

40. A method for testing performance characteristics of building blocks, which may be identical or different, of a library of materials, comprising the following steps:
(4) testing at least one library building block with respect to at least one performance characteristic; and
(5) detecting at least one measurable quantity, to which at least one performance characteristic of the at least one library building block can be assigned, by at least one sensor;
wherein at least one of the steps (4) and (5) is performed continuously.

41. A method in accordance with claim 40, comprising the following further step:
(1) storage of a set M of n library building blocks, wherein n is an integer≧2.

42. A method in accordance with claim 41, comprising the following further step (3):
(3) forming at least one partial set Mᵢ out of the set M having a number nᵢ of building blocks, by means of a selecting operation, wherein 1≦nᵢ<n and i is a natural number.

43. A method in accordance with claim 42, further comprising:
(6) evaluating the at least one detected quantity from step (5) in an evaluation operation; and
(7) partitioning the building blocks of the at least one partial set Mᵢ based upon the results of the evaluation operation in step (6) into Z partial sets M_{iz}, each with a number of nⱼ building blocks, wherein 1≦Z≦n and 1≦j≦n and j is a natural number, in a partitioning operation;
wherein an unambiguous assignment of the at least one detected measurable quantity to the respective partial set Mᵢ is performed.

44. A method in accordance with claim 41, further comprising:
(2) conditioning the set M of library building blocks in a conditioning operation.

45. A method in accordance with claim 43, further comprising:
(8) combining partial sets M_{iz}, the building blocks of which were assigned to the same class within the evaluation operation.

46. A method in accordance with claim 40, further comprising:
(T) transporting a set of library building blocks by means of a transport operation via a spatial pathway.

47. A method in accordance with any one of claims 40-46, wherein at least one of the steps is performed continuously.

48. A method in accordance with claim 46, wherein at least the following steps are performed continuously:
(1)-(2); (1)-(2)-(3); (1)-(2)-(3)-(4); (1)-(2)-(3)-(4)-(5); (1)-(2)-(3)-(4)-(5)-(6); (1)-(2)-(3)-(4)-(5)-(6)-(7); (1)-(2)-(3)-(4)-(5)-(6)-(7)-(8); (1)-(2)-(3)-(4)-(5)-(6)-(7)-(8)-(T).

49. A method in accordance with any one of claims 40-46, wherein all steps are performed continuously.

50. A method in accordance with any one of claims 40-46, characterized in that at least one of the steps is performed without a substrate.

51. A method in accordance with any one of claims 40-46, characterized in that all steps are performed without a substrate.

52. A method in accordance with any one of claims 40-46, wherein the steps are arbitrarily repeated and/or combined.

53. A method in accordance with any one of claims 40-46, wherein parts of or the totality of the steps are performed with equal or various parameter sets P.

54. A method in accordance with claim 53 wherein the parameter set P comprises physical, chemical, mechanical and/or biological parameters which are not constant with regard to time, if need be, as well as combinations of two or more parameter sets P.

55. A method in accordance with any one of claims 40-46 wherein the testing is performed within a reaction chamber.

56. A method in accordance with claim 55, wherein the geometrical shape and/or size and/or position of the reaction chamber changes prior to, during, or after a step or an operation.

57. A method in accordance with any one of claims 40-46 wherein the steps or the operations performed in these steps, are completely or partially performed in parallel.

58. A method in accordance with any one of claims 40-46 wherein the operations performed in the steps are connected by freely selectable combinations of logical interconnections, depending on intrinsic and/or extrinsic conditions.

59. A method in accordance with claim 58 wherein the logical interconnections are chosen from the group: AND, OR, NAND, NOR, XOR, XNOR, NOT as well as combinations thereof.

60. A method in accordance with claim 58 wherein, in order to create the at least one condition for the creation of the at least one logical linkage, one operator is chosen from the group: < (smaller than), ≦ (smaller than/equal to), = (equal to), ≠ (different from), ≧ (bigger than/equal to), > (bigger than).

61. A method in accordance with any one of claims 40-46, wherein the steps as well as the operations performed within the steps are partially or completely automated.

62. A method in accordance with any one of claims 40-46 wherein the partially or completely automated control of the steps as well as of the operations performed within the steps are partially or completely self-optimized within an expert system.

63. A device for continuous testing for performance characteristics of building blocks, which may be identical or different, of a library of materials, comprising:
(3) means for adding and/or discharging at least one fluid medium; and
(4) means for testing the building blocks for at least one performance characteristic.

64. A device in accordance with claim 63, further comprising:
(1) at least one storage container with a set M of building blocks.

65. A device in accordance with claim 64 further comprising:
(2) at least one device for creating the at least one partial set Mᵢ out of the set M, having a number nᵢ of building blocks.

66. A device in accordance with claim 63, further comprising:
(5) means for intermediate storage of building blocks.

67. A device in accordance with claim 63, further comprising:
(6) means for the transport and/or substrate-free transport of the building blocks.

68. A device in accordance with claim 63 further comprising:
means for the substrate-fee transport of building blocks.

69. A device in accordance with claim 63 further comprising:
means for the conditioning of building blocks.

70. A device in accordance with claim 63 further comprising:
means for screening the building blocks.

71. A device in accordance with claim 63, further comprising means for automation.

72. A device in accordance with claim 71, characterized in that the means for automation are partially or completely interconnected within an expert system.

73. A device for continuous conditioning and production or continuous conditioning or production of building blocks, which are identical or different, of a library of materials, comprising:
(1) at least one storage container with the set M of building blocks;
(2) at least one device for creating the at least one partial set Mᵢ from the amount M with a number nᵢ of building blocks; and
(3) means for charging and/or discharging at least one fluid medium.

74. A method for the conditioning and production or conditioning or production of building blocks, characterized in that said method is performed continuously.

75. Use of the method in accordance with any one of claims 40-46 and 74 for realizing identical or different algorithms in the production, processing and/or testing of building blocks of a library of materials.

76. Use of the device in accordance with any one of the claims 63-73 for the performance of the method in accordance with any one of the claims 40-46 and 74 for the continuous testing and/or production of heterogeneous catalysts.

77. A computer program with program code means for the performance of the method in accordance with any one of claims 40-46 or for the control/regulation of the device in accordance with any one of claims 63-73.

78. A data carrier with a computer program in accordance with claim 77.
